(19) United States
(12) Patent Application Publication
(10) Pub. No.: US 2007/0003694 A1
(43) Pub. Date: Jan. 4, 2007

(54) In-flight modification of inorganic particles within a reaction product flow

(76) Inventors: Shivkumar Chiruvolu, San Jose, CA (US); Hui Du, Sunnyvale, CA (US); William E. McGovern, Lafayette, CA (US); Ronald J. Mosso, Fremont, CA (US); Nobuyuki Kambe, Menlo Park, CA (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 11/438,477

(22) Filed: May 22, 2006

Related U.S. Application Data
(60) Provisional application No. 60/683,650, filed on May 23, 2005.
(60) Provisional application No. 60/694,389, filed on Jun. 27, 2005.
(60) Provisional application No. 60/778,707, filed on Mar. 3, 2006.

(51) Int. Cl. B05D 3/00; B05D 7/00; B05D 1/12; B29C 71/04; B05B 5/025

(52) U.S. Cl. 427/180; 427/212; 427/532; 118/620

(57) ABSTRACT

Methods involve in-flight processing of inorganic particles synthesized within the flow. Thus, the flow extends from an inlet connected to a reactant delivery system with inorganic particle precursors to a collector. The as formed inorganic particle can be modified with radiation and/or the application of a coating composition. Additional processing steps can be introduced as desired. Suitable apparatuses for in-flight processing can be based on addition of processing elements onto an inorganic synthesis reactor, such as a laser pyrolysis reactor.

### CROSS REFERENCE TO RELATED APPLICATIONS

This patent application claims priority to copending U.S. Provisional Patent Application Ser. No. 60/683,650 filed on May 23, 2005 to Chiruvolu et al., entitled “Toners, Other Polymer-Inorganic Particle Composite Particles and Corresponding Processes,” to copending U.S. Provisional Patent Application Ser. No. 60/694,389 filed on Jun. 27, 2005 to Chiruvolu et al., entitled “Toners, Other Polymer-Inorganic Particle Composite Particles and Corresponding Processes,” and to copending U.S. Provisional Patent Application Ser. No. 60/778,707 filed on Mar. 3, 2006 to Chiruvolu et al., entitled “In-Flight Modification of Inorganic Particles Within a Reaction Product Flow,” all three of which are incorporated herein by reference.

### FIELD OF THE INVENTION

The invention relates to processes for the manipulation of inorganic particles following formation of the particles within a reactive flow. In particular, the invention can relate to processes and corresponding apparatuses for the application of a composition, such as an organic composition, on the surfaces of inorganic particles, formed in a reactive flow, which can involve driving the reaction with an intense light source. Similarly, the invention relates in some embodiments to the interaction of inorganic particles in a reaction product flow with radiation to modify the properties of the particles. The invention further relates to submicron inorganic particles with a coating over the particles in which the particles are substantially free of hard fusing.

### BACKGROUND OF THE INVENTION

Inorganic particles find a wide range of commercial uses with sales in the millions of tons. While selection of the composition of the inorganic material can significantly influence the resulting properties of the particles, combining these inorganic powders with other compositions can greatly multiply the range of properties available for the resulting composites. For example, inorganic particles, such as titanium dioxide, can have a high index-of-refraction, which can be incorporated into a composite. Composite compositions are finding wider acceptance based on the realization of desirable properties resulting from the combination of compositions that contribute features associated with the different components.

With advances in many technologies, distance scales for processing are shrinking to form more complex structures within smaller footprints. This shrinking of complex structures is placing increasing demands on material preparation while simultaneously applying cost constraints. To meet these growing material demands, nanoscale materials are finding growing commercial uses as further miniaturization takes place in a wide range of technologies.

### SUMMARY OF THE INVENTION

In a first aspect, the invention pertains to a method for the performance of in situ modification of inorganic particles formed within a reactive flow, the process comprising directing radiation, an organic or silicon-based coating composition, or a combination thereof to a product inorganic particle flow downstream from a reaction zone at which the inorganic particles are formed to form in situ modified inorganic particles. In some embodiments, a coating composition is directed at the inorganic particles to form of inorganic particles with a coating. The coating composition generally is an organic composition or a silicon-based composition and can be, for example, a surface modifier, a pigment, polymerizable monomers, crosslinkable oligomers, a polymer solution or the like. The coating composition may or may not chemically react with the surface of the inorganic particles. For relevant embodiments, the deposition of a coating composition on the inorganic particles results in composite particles. The inorganic particles produced in the reactive flow can be cooled with an inert gas or other approach prior to the application of a coating composition.

Radiation can be used to modify the inorganic particle properties, such as crystallinity and/or purity, and/or radiation can be used to modify coating properties. Suitable radiation can be, for example, ultraviolet light, an electron beam, a corona discharge, x-rays, visible light, microwaves, infrared light, combinations thereof or the like. Radiation can be directed to the flow following the deposition of a coating composition to induce polymerization, crosslinking and/or other suitable modification of the coating composition.

The flow generally is initiated with a reactant delivery system that interfaces at an inlet nozzle with the reaction system. The reaction to form inorganic particles can be driven by an intense light beam to form the inorganic product particles within the flow. A reaction zone can be located at the intersection of a reactant flow and a light beam such that the inorganic particle production process involves a light induced pyrolysis, generally referred to as laser pyrolysis.

In a further aspect, the invention pertains to an apparatus comprising a reactant delivery system, a flow path, an energy source, a coating nozzle and a collection system. The reactant delivery system comprises precursors that react to form inorganic particles in response to suitable energy and can be configured, for example, to deliver vapor and/or aerosol reactants from an inlet nozzle. The energy source generally is configured deliver excitation energy to a reactant flow of inorganic particle precursors within a flow path from the reactant delivery system. The flow path generally is directed through a reaction chamber sealed from the ambient environment. The interaction of energy from the energy source and flow from the reactant delivery system establishes a reaction zone for inorganic particle formation. The reaction zone can correspond to a location at which thermally driven reactions take place. But in some embodiments of particular interest, the reactions are driven with energy from an intense light beam that intersects the reactant flow to induce reaction within the reaction zone. This process driven with an intense light beam has been termed laser pyrolysis, although an intense non-laser light source can be used. For light driven embodiments, the apparatus can comprise an optical path from an intense light source that intersects the reactant stream.

A product inorganic particle stream flows from the reaction zone as the reactant stream is converted into a product stream. The coating nozzle can be operably connected to a source, for example, of organic or silicon-based coating composition. The coating nozzle can be oriented to deliver the coating composition to intersect the inorganic particle product stream in the reaction chamber or within a collection conduit or other chamber. In some embodiments, the flow has an elongated dimension such that the a cross section perpendicular to the flow has an aspect ratio significantly greater than 1, such as greater than about 5, with a width generally no more than about the width of the light beam.

In other aspects, the invention pertains to an apparatus comprising a reactant delivery system, a flow path, an energy source, a radiation source and a collection system. The reactant delivery system comprises precursors that react to form inorganic particles in response to suitable energy and can be configured, for example, to deliver vapor and/or aerosol reactants from an inlet nozzle. The energy source is configured to deliver excitation energy to a reactant inorganic particle precursor flow from the reactant delivery system. The flow path generally is directed through a reaction chamber sealed from the ambient environment. The radiation source is configured to interact with the flow following the formation of inorganic particles. Interaction of the inorganic particles with radiation can result in a change in crystal structure and/or a change in oxidation state.

Additionally, the invention pertains to processes that combine in-flight a plurality of inorganic particle flows formed in separate reactive flows and that modify these inorganic particles to form corresponding composites. These processes take advantage of the ability to modify in-flight inorganic particles from a reactive flow. In this way, complex composites, such as submicron toner particles, can be formed completely with an in-flight process. The interaction of the independent inorganic particle flows can be designed to reduce agglomeration through the avoidance of interacting particles too close to their reaction zone so that the particles have cooled before they interact and through blending the particle flows at an oblique angle so that the relative momentum of the particles does not favor agglomeration.

In some embodiments, the plurality of independent inorganic particles flows is combined to form a blended inorganic particle flow prior to performing modifications with a coating composition or the like. In additional or alternative embodiments, the inorganic particles in one or more product flows can be modified prior to combining the particles with other inorganic product particle flows. A plurality of modification steps can be performed as appropriate to achieve the desired composite product.

In addition, the invention pertains to in-flight processing approaches in which there is a coating composition in-flight processing channel and a reactive inorganic particle production channel. In this context, coating composition processing is intended to include, for example, further processing of organic compositions, silicon-based compositions, oligomer processing, polymer processing and the like. The products from the separate channels are combined to form composite particles. The particles from the reactive inorganic particle production pathway can be modified with a coating composition, such as a surface modifier, prior to interacting with products from the organic in-flight processing channel. The coating composition in-flight processing channel can comprise a range of processing options, which can lead, for example, to pigmented polymer particles within the in-flight processing channel. The organic compositions can be subjected to electrons and/or ultraviolet radiation or other suitable radiation to induce polymerization and/or crosslinking of monomers, oligomers or polymers within the organic droplets either before and/or after combining the organic droplets with the inorganic particles. Suitable processes within the coating composition processing channel include, for example, drying, crosslinking, polymerization, chemical modification, combinations thereof and the like.

### BRIEF DESCRIPTION OF THE DRAWINGS

FIG. 1 is a schematic, fragmentary side view of a modified inorganic particle production system.

FIG. 2 is a schematic side view of a laser pyrolysis reaction chamber with an elongated reactant inlet for a high throughput based on a sheet of flow.

FIG. 3 is a schematic diagram of a reactant delivery system with a gas/vapor precursor sources.

FIG. 4 is a schematic diagram of a reactant delivery system with a gas delivery subsystem, a vapor delivery subsystem and a mixing subsystem.

FIG. 5 is a sectional front view of an aerosol delivery system in which the section is taken along line 5-5 of the insert showing a top view of the aerosol delivery system.

FIG. 6 is a sectional side view of the aerosol delivery system of FIG. 5 taken along line 6-6 of the insert of FIG. 5.

FIG. 7 is a schematic view of three alternative configurations of a coating composition delivery nozzle relative to a product flow of inorganic particles.

FIG. 8 is a fragmentary top view of a coating composition delivery nozzle with two elements oriented around a product flow of inorganic particles.

FIG. 9 is a fragmentary top view of an embodiment with a coating composition delivery nozzle with four elements oriented around a product flow of inorganic particles.

FIG. 10 is a fragmentary top view of an embodiment with a coating composition delivery nozzle that surrounds a product flow of inorganic particles.

FIG. 11 is a front view of a panel of radiation sources aligned along the panel.

FIG. 12 is a partially cut-away perspective view of an embodiment of a reaction system with a coating composition delivery nozzle within a reaction chamber set up for the laser pyrolysis-based synthesis of inorganic particles, in which a wall of the reaction chamber is cut away to expose the interior of the reaction chamber.

FIG. 13 is a schematic perspective view of a flow system configured with a plurality of flow modification stations that can each comprise independently a radiation source or a coating composition delivery nozzle.

FIG. 14A is a fragmentary, sectional view through the wall of a reaction chamber adapted with a thin film delivery approach.

FIG. 14B is a fragmentary, perspective view of the joining of the inner walls of the reaction chamber walls shown in FIG. 14A.

FIG. 15A is a fragmentary, sectional view through the wall of a reaction chamber with an alternative embodiment adapted for a thin film delivery.

FIG. 15B is a fragmentary, perspective view of the joining of the inner walls of the reaction chamber of the reaction chamber walls shown in FIG. 15A.

FIG. 16A is a fragmentary, sectional view of another alternative embodiment of the wall of the reaction chamber configured for thin film delivery, in which the inner wall includes wall segments that are connected by spacers to form the inner wall. The cross section is taken through a section of chamber wall along a direction parallel to reactant flow in the chamber.

FIG. 16B is a fragmentary sectional view of the chamber wall shown in FIG. 16A, where the section is taken along line B-B.

FIG. 17 is a fragmentary, section view of the wall of the reaction chamber with a porous inner wall for the delivery of gas or vapor from a delivery channel within the wall.

FIG. 18A is a fragmentary sectional view of the wall of the reaction chamber with notches in the inner wall for the delivery of vapor into the reaction chamber from a delivery channel within the wall.

FIG. 18B is a fragmentary side view of a section of an inner, reaction chamber wall with notches for the delivery of inert gas.

FIG. 19 is a cut away perspective view of a laser pyrolysis apparatus configured to form two independent inorganic particle product streams.

FIG. 20 is a flow diagram outlining various embodiments involving a plurality of in-flight processing streams with inorganic and/or organic/polymer channels.

FIG. 21 is a flow diagram indicating various optional processing steps for some representative embodiments of the processing approaches described herein for modifying in-flight inorganic particles within a flow.

FIG. 22 is a flow diagram depicting an embodiment of an in-flight process to form a coating composition for delivery to an inorganic particle flow.

FIG. 23 is a schematic sectional view of a representative composite particle with a layered coating.

FIG. 24 is a schematic sectional view of an alternative embodiment of a composite particle having a core with agglomerated inorganic particles.

FIG. 25 is a plot of infrared transmission as a function of frequency (inverse wavelength) for four different epoxy-silane modified rutile titanium dioxide nanoparticle powders.

FIG. 26 is a transmission electron micrograph of epoxy-silane modified rutile titanium oxide nanoparticles.

FIG. 27 is a plot of solution phase particle size measurements for two dispersed samples of epoxy-silane modified titanium dioxide samples.

### DETAILED DESCRIPTION OF THE INVENTION

Based on the approaches described herein, inorganic particles synthesized within a flow can be modified in-flight before their collection. In particular, the inorganic particles can be interacted with radiation to modify the inorganic particle properties and/or the inorganic particles can be coated in flight. Performance of the processing steps in-flight significantly improves efficiency of processing for forming some composite materials since some difficult processing steps can be avoided. The inorganic particles in the reactive flow in which they are formed can be essentially well separated such that the processing of the particles can effectively modify the individual inorganic particles. Also, interacting the inorganic particles with appropriate radiation can alter the particle structures, for example, to alter the crystal structure, while the particles have not fully cooled. Inert gasses can also be delivered to the flow to cool the particles, if desired, as well as to further control the flow as it proceeds through the apparatus. Processing of the inorganic particles in the flow can involve pacifying the particle surfaces such that the collected particles are more easily dispersed for use.

For inorganic particles formed within a reactive flow, the performance of an in-flight coating or other in-flight modifications within the flow can generate uniform and substantially unfused composite particles or modified inorganic particles without the need to disperse the inorganic particles within a liquid for forming a composite or heating inorganic particles in a bulk powder where undesired sintering can take place. In some embodiments, the composite particles are submicron. The formation of inorganic core particles within the reactive flow can be driven by an intense light beam to generate highly uniform inorganic particles, although other reactive processes within a flow can be used. These in-flight processes can be efficient for the production of uniform composite particles with selected properties and compositions as well as for forming modified inorganic particles without a coating.

A coating composition can be delivered to the product inorganic particles within the flow in the form of a vapor and/or aerosol. The coating composition can comprise, for example, organic compositions, organometalic compositions and/or silicon-based compositions. Through the selection of the inorganic particle compositions, the coating compositions, particle sizes and the relative amounts of the materials, composite particles with a wide range of properties can be formed. Some in-flight approaches can involve combinations of inorganic particles from separate reactive flows. In additional or alternative embodiments, in-flight processing of organics can be performed prior to combining in flight the product organics with a flow of inorganic product particles. Radiation can be delivered to the flow to modify the inorganic particle properties and/or to modify coating compositions applied to the inorganic particles.

Product composite particles generally comprise an inorganic particle core with a coating comprising an organic or silicon-based non-mineral material. In some embodiments, the composites can comprise a plurality of coatings. The relative amounts of the inorganic core versus the coating material can be adjusted to yield desired composite particle properties. Due to the formation of the composite particles in-flight, the resulting composite particles can be essentially unfused such that the composite particles can be individually dispersed following collection. The properties of the inorganic core particles and/or the surface coating can be modified in flight through the application of radiation, such as ultraviolet light, infrared light, an electron beam, or the like, to the particles. Property modification in-flight can further pacify the coating to reduce or eliminate hard agglomeration or fusing of the composite particles following collection of the particles.

The formation of the composite particles can be based on a reactive flow to form inorganic particles that are subsequently processed in-flight. In embodiments of particular interest, the inorganic particles are formed in a reaction driven with an intense light beam, which has been termed laser pyrolysis. Laser pyrolysis techniques have been developed for the synthesis of a very wide range of inorganic particles with or without dopants and/or a complex composition with a plurality of metal/metalloid elements. However, in some embodiments, the inorganic particles can be formed in a flow through a flame reactor (flame synthesis) or through a tube furnace (thermal combustion synthesis) or the like.

In general, the modification of the inorganic particles, with radiation and/or a coating application, can take place within the reaction chamber, within a conduit separate from the reaction chamber and/or within a separate coating chamber which received the inorganic particles in-flight. In-flight processes imply that the inorganic particles formed in situ are never collected in a vessel with no net forward momentum prior to completion of all the in-flight processing. Correspondingly, flow refers to its conventional meaning relating to a net movement of mass from one location to another, which in this case is from reactant inlets to a collector. As an example, for laser pyrolysis the application of a coating over the inorganic particles can take place conveniently within the reaction chamber since the inorganic particles are quenched rapidly after leaving a well defined reaction zone, although a cooling inert gas can also be used prior to applying a coating. If a plurality of coatings are applied, these may or may not be applied within the same portion of the apparatus. Thus, for example, a first coating can be applied in the reaction chamber, and a second coating can be applied in a conduit leading from the reaction chamber.

In general, to form a coating, a coating composition is directed to intersect the flow of inorganic particles, which can become the cores of the composite particles. For convenience, we refer to a coating composition as a composition applied to form a coating while the coating is the resulting material on the collected composite particles. Since the coating may be modified relative to the coating composition due to, for example, internal reactions of one or more coating compositions, reactions with the inorganic particles, modification due to solvent evaporation and/or modification due to radiation, the composition of the coating can be different from the coating composition.

For embodiments with in-flight preparation of composite particles having a plurality of types of inorganic particles, one or more of the individual flows of product inorganic particles may or may not be modified prior to combining the inorganic particles. For example, a flow of product inorganic particles or a blended flow of a plurality of inorganic particles can be surface modified or assembled into a composite particles, such as polymer composites and/or composites with pigments or other functional molecules, prior to combining with another flow of modified or unmodified inorganic particles. If composite particles are formed with one or more inorganic particles, these composite particles can be combined with modified or unmodified inorganic particles from a separate reactive flow to surface modify the composite particles with the inorganic particles from the separate flow.

The apparatus generally comprises a reaction chamber where a reaction takes place to form inorganic particles within a flow. The flow can be initiated with compositions comprising precursors for the inorganic particles, which are delivered from a reactant delivery portion. The flow can be supplemented with additional compositions at various stages for the formation of composite particles which are ultimately collected. To form the inorganic particles in a relatively controlled environment, the apparatus generally has an energy source that initiates the reaction to form the inorganic particles. In embodiments of particular interest, the reaction is driven with an intense light beam in a process generally referred to as laser pyrolysis. However, thermal reactors, flame reactors or the like can be alternatively used to form the inorganic particles.

The apparatus further comprises one or more radiation sources and/or coating elements for modifying the inorganic particles in the flow. The radiation sources and/or coating elements can be positioned to interact with inorganic particle flow within the reaction chamber in which the inorganic particles are formed or in conduits to which the flow is directed out from the reaction chamber. Modification elements can be appropriately positioned in the apparatus for form desired composite particles or modified inorganic particles. Various embodiments for the placement of radiation sources and coating elements are described further below. The modified inorganic particles or composite particles are ultimately collected to terminate the flow that is initiated with inorganic particle precursors.

The apparatus can be configured to direct the coating composition relatively uniformly at the product inorganic particle flow. To accomplish this delivery of coating composition, one or more inlets can be used to deliver the coating composition into the flow. In some embodiments, the flow is in the form of a sheet with a relatively small thickness and a relatively large width, which can be visualized with a conceptual plane cutting through perpendicular to the flow. The coating composition inlets can be configured to approximately conform with this flow geometry to yield a more uniform coating over the inorganic particles. The nature of the coating composition inlet can be configured to yield the desired uniformity for the selected amount of coating composition without undesirably disrupting the flow.

The apparatus can be configured to deliver radiation to the flow relatively uniformly. In particularly, suitable radiation sources can be configured to roughly match the configuration of the flow. Suitable radiation sources can be selected to deliver electromagnetic radiation at a desired wavelength range, an electron beam, a corona discharge, or the like.

A plurality of independent inorganic particle flows can be generated within a single reaction chamber, in a plurality of distinct reaction chambers or a combination thereof. In embodiments in which a plurality of product inorganic particle flows are generated in a single reaction chamber, the flows can be oriented within the chamber for combination within the reaction chamber to form a particle blend, or the reactive flows can be configured to be combined within a flow system external to the reaction chamber. If the particles are produced by laser pyrolysis, a separate light beam can be directed into the chamber for each individual reactive flow, or the reactive flows can be generated with an orientation such that single light beam intersect with the different reactive flows, or optics can be used to direct a single light beam to intersect a plurality of reactive flows. Similarly, for each product inorganic particle flow, modification of the inorganic particles, if performed on separate inorganic product particle flows, can be performed within the reaction chamber or after the particles are flowed from the reaction chamber.

In embodiments of particular interest, the inorganic core particles have an average diameter of no more than a micron. The inorganic core particles can be crystalline, amorphous or combinations thereof. Similarly, the particles can be roughly spherical, rod shaped, plate shaped or other shapes. Interacting radiation with the particles formed in the reactive flow can be used to alter the form of the inorganic core particles in-flight prior to delivery of the coating composition or after delivery of the coating composition if the radiation can still alter the inorganic core with the coating composition present.

The core inorganic particles generally comprise metal or metalloid elements in their elemental form and/or in metal/metalloid compounds. Specifically, the inorganic particles can include, for example, elemental metal or elemental metalloid, i.e. un-ionized elements or alloys thereof, metal/metalloid oxides, metal/metalloid nitrides, metal/metalloid carbides, metal/metalloid sulfides, metal/metalloid silicates, metal/metalloid phosphates, combinations thereof or blends thereof. As used herein, inorganic particles include elemental carbon particles, such as fullerenes, carbon black, carbon nanotubes, graphite and combinations thereof. Inorganic particles excluding carbon particles can be referred to as non-carbon inorganic particles, which comprise a metal and/or a metalloid in an ionized or un-ionized form.

Metalloids are elements that exhibit chemical properties intermediate between or inclusive of metals and nonmetals. Metalloid elements include silicon, boron, arsenic, antimony, and tellurium. Astatine perhaps can be considered a metalloid also, but it is highly radioactive with the longest lived isotopes having a half life of about 8 hours. While phosphorous is located in the periodic table near the metal elements, it is not generally considered a metalloid element. However, P₂O₅ and doped forms of P₂O₅ are desirable materials similar to some metalloid oxides, and other optical materials doped with phosphorous, e.g., in the form of P₂O₅, can have desirable optical properties. For convenience, as used herein including in the claims, phosphorous is also considered a metalloid element.

Elements from the groups Ib, IIb, IIIb, IVb, Vb, VIb, VIIb and VIIIb are referred to as transition metals. In addition to the alkali metals of group I, the alkali earth metals of group II and the transition metals, other metals include, for example, aluminum, gallium, indium, thallium, germanium, tin, lead, bismuth and polonium. The non-metal/metalloid elements include hydrogen, the noble gases, carbon, nitrogen, oxygen, fluorine, sulfur, chlorine, selenium, bromine, and iodine.

A coating over the particles can comprise one or more organic and/or silicon-based compositions. Suitable organic compositions include, for example, surfactants, polymers, monomers, dyes, biomolecules, and the like. Suitable silicon compounds include, for example, silicon polymers, silicon compositions with functional groups that bond with the inorganic particles or with functional groups of a polymer, and the like. Polymers within the coating may or may not be crosslinked. Suitable biomolecules include, for example, proteins, carbohydrates, fatty acids, nucleic acids, derivatives thereof, and combinations thereof. In general, the coating compositions are non-mineral in nature to distinguish the coatings from the inorganic particles, which generally are mineral or ceramic in nature with a crystalline or amorphous lattice having at least a short range order.

If the coating comprises a plurality of compositions, these different compositions may or may not be within the same coating and/or in different coatings, i.e., different layers of coating composition. If a plurality of coating components are within a single coating layer, the coating components may or may not be uniformly distributed in the coating around the inorganic cores. If the particles have a plurality of coatings comprising different compositions, the adjacent coatings may or may not be chemically bonded to each other at the interface between the layers. Compositions within the coating may be ordered within a layer, such as an ordered block copolymer. It may be equivalent whether or not a particular structure is described as a plurality of layers bonded to each other at an interface or as a single ordered layer.

In some embodiments, the composite particles have chemical bonding between the inorganic particles and the coating, which may or may not involve a linker compound mediating the bonding of the coating composition with the inorganic particle. Chemical bonds, as used herein, generally has at least some covalent bond character and specific interactions, as distinguished from non-specific bonding, such as adhesive bonding, that involves a large number of weak, non-specific interactions and generally a significant entropic contribution. In other embodiments, the composite particles comprise a coating composition over the surface of the inorganic particle without chemical bonding to the inorganic particle such that nonbonding interaction with the particle and internal interactions within the coating composition stabilize the coating composition on the inorganic particle core. The composition of the components of the composite particles and the relative amounts of the components can be selected to yield desired properties.

In embodiments of the composite particles involving chemical bonding between a coating and the inorganic particles, the coating composition can be selected to comprise appropriate functional groups to chemically bond with the inorganic particles or with functional groups of a linker compound. A linker compound can facilitate the formation of the resulting bonded composite. In embodiments with monomer units being joined to the linker compound, a polymer is formed with the formation of the composite. For simplicity in notation, the monomer/polymer unit joined with the linker and assembled into the composite is referred to generally as a polymer, although it is recognized that in some cases the unit can be a monomer or polymer, such as a dimer, trimer or larger polymer structures. The molecular weights of the polymers can be selected to vary the properties of the resulting composite particles, and the crosslinking can be such that the coating is effectively a single molecule.

The coatings described herein are substantially different from sequential inorganic coatings. For example, U.S. Pat. No. 6,803,073B to Doan, entitled Particle Forming Method,” incorporated herein by reference, describes two sequential laser pyrolysis steps within a flow such that the reaction of a second precursor stream results in the nucleation of an inorganic coating composition over the initially formed core inorganic particles. The present approach is quite distinct since the inorganic particles do not flow through a light reactive zone with energy/heat sufficient to drive a laser pyrolysis process. In addition, the coatings described herein are distinct from the inorganic coatings described in the '073 Doan patent.

Methods for synthesizing inorganic particles in commercial quantities with particular high uniformity include, for example, light-based pyrolysis/laser pyrolysis in which light from an intense electromagnetic radiation source drives the reaction to form the particles. For convenience, this application refers to light-based pyrolysis and laser pyrolysis interchangeably, since a suitable intense source of electromagnetic radiation can be used in place of a laser. In laser pyrolysis, the particles quench relatively rapidly after leaving the light reactive zone. Laser pyrolysis is useful in the formation of particles that are highly uniform in composition and size.

While the core inorganic particles can be synthesized using suitable flow methods, laser pyrolysis offers significant advantages for the formation of composite particles in-flight. With laser pyrolysis, a flow of reactants intersects an intense light beam such that a reactive zone is formed in the vicinity of the intersection of the reactive flow and the intense light beam. The product particles are quenched rapidly after leaving the reaction zone. Having a well defined reaction zone facilitates placement of a coating system within the reaction chamber to apply a coating composition to the inorganic particles in the flow. Also, laser pyrolysis with a well defined reaction zone provides for the formation of a wide range of nanoscale particles with selected compositions and uniform sizes.

While the particles quench relatively rapidly in laser pyrolysis, with laser pyrolysis or other flowing reaction methods, it can be desirable to further cool the particles prior to the addition of a coating composition. In particular, the particles can be cooled by contacting the flow with a flow of inert gas, such as N₂. The degree of cooling can be adjusted to provide the particles with an appropriate temperature for combination with a coating composition.

High-quality inorganic nanoparticles to form nanocomposites can be produced on a commercial scale, as described in U.S. Pat. No. 5,958,348 to Bi et al., entitled “Efficient Production of Particles By Chemical Reaction,” incorporated herein by reference. In particular, these systems and other similar systems have a flow that is elongated in one direction such that the flow has the shape of a sheet. In some embodiments, this sheet of flow can be modified appropriately with a coating composition to result in a high through put composite particles generally formed in a sheet of flow. Thus, the approaches discussed herein provide for high quality unfused composite particles formed very efficiently in-flight, which can be produced at commercial volumes. With this combination of qualities, the processes herein involve a significant leap in advanced technological materials processing.

The use of uniform nanoscale inorganic particles within the composite particles can impart improved and/or desired properties for some applications. Furthermore, it is desirable to have particles in which the inorganic particles are substantially unfused in the core such that the resulting composite particles can have a higher degree of uniformity and corresponding uniformity of properties. Also, if a coating is appropriately applied and the surface is pacified, the composite particles can be similarly substantially unfused.

To form a coating on the particles within the flow, a coating composition can be directed to intersect the flow of inorganic particles. The coating composition prior to delivery into the flow can comprise, for example, a vapor, a neat liquid, a liquid solution, a liquid dispersion or combinations thereof. For appropriate embodiments, suitable solvents/dispersants can be selected, which can be, for example, aqueous liquids, organic liquids, silicon-based liquids or suitable combinations thereof. The coating composition can then be delivered into the flow as a vapor or aerosol. The resulting coating can comprise the coating composition to the extent the coating composition just condenses onto the particles in the flow. However, in many embodiments, the coating comprises a modified composition relative to the coating composition. The modification, for example, can comprise an evaporation of a solvent to solidify the non-volatile components of the coating composition onto the surface of the particles.

In additional or alternative embodiments, the coating composition or a component thereof reacts with the surface of the inorganic particle to form a bonded structure. In some embodiments, components of the coating composition react with themselves, other components of the coating composition or a combination thereof, which can be polymerization and/or crosslinking reactions. The various reactions can be spontaneous, driven by mixing of reactive components within the flow, driven by heat from the inorganic particles and/or driven by energy from radiation directed at the flow. Suitable reactions include, for example, decomposition reactions, addition reactions, polymerization reactions and/or crosslinking reactions. Through one or more of these mechanisms, a wide range of coating and composite compositions can be formed, as desired for particular applications.

A plurality of coating compositions can be applied to a flow of inorganic particles to form a single coating or a plurality of coatings. For example, to form a single coating, the plurality of coating compositions can be compatible such that they blend, possibly before a transition to a solidified form. In alternative or additional embodiments, a plurality of coating compositions react with each other to result in a product coating within a single layer of the composite particle. In further embodiments, the plurality of coating compositions segregates into separate layers, which may or may not be bonded at the interface surface. Various combinations of such layered structures are possible. In some embodiments, the precise structure may not be directly observable, although the structure may be inferred from the known chemical properties of the composition and possible the use of spectroscopic techniques to infer the interactions between the species and the chemical composition of the coating.

In general, the relative weights of the coating and the inorganic particle can be selected over a wide range to yield the desired composite properties. For embodiments in which an inorganic particle functions essentially as a nucleation point for assembling the coating to form un-fused composite particles, the inorganic particle may be relatively small depending on the desired final particle size. However, in some embodiments, the coating is a thin overcoat over the inorganic particle in which the overcoat modifies the surface properties, optical properties or other property in which a large amount of the coating material is not required to achieve the desired property modification. In particular, the weight ratio of inorganic core particles to the coating generally can range from about 1000 to about 1×10⁻⁷.

In general, the inorganic particles have an average diameter from about 2 nm to about 500 nm. The resulting collection of composite particles generally is desired to have at least about 50 percent of the particles having a coating. The coating can have an average thickness from about 1 nm to about 1 micron. However, the coating may or may not be uniform over the particle surface, and the coating may or may not have a uniform thickness within the collection of particles. In particular, relatively thin coatings on average may only cover a portion of the particle surface on average. Therefore, if it is desirable for the coating to cover the entire surface for most particles it may be appropriate to deposit a greater relative amount of coating composition. Furthermore, the selection of a coating composition with appropriate surface tension properties and viscosity can result in a coating with more or less uniformity over the inorganic core. For different applications, the uniformity of the coating over the inorganic core can be more or less important. Also, the coating process and apparatus influences the uniformity of the coating.

For some applications, it is desirable for the composite particles to be substantially unfused with respect to subsequent dispersion. The concept of hard fusing is not a simple one since small particles generally at least weakly attach to some degree in a powder, but in a reactive flow where the particles are synthesized, the particles may remain more physically distinct in comparison with a corresponding powder. Due to the high surface area of the particles, weak non-bonding forces tend to hold particles together if the particles are in a powder. However, weak forces can be disrupted by a fluid such that the particles can be separated, although the disruption can be slow or otherwise hard to accomplish. Milling and the like can be used to facilitate the dispersion of the particles. On the other hand, strong bonding forces cannot generally be disrupted without applying correspondingly harsh forces to break these strong interactions. Thus, hard fused inorganic particles have bonding forces that cannot be disrupted without correspondingly intense forces, such as high shear milling, applied to break the particles, which can damage crystallinity or other particle characteristics as well as resulting in significant non-uniformity.

With organic, silicon-based or polymer coatings, interface properties can be similarly complex. The sticking of coatings of adjacent particles may depend on the viscosity, the miscibility, the mobility and the like of the coating molecules. Thus, for example, polymer chains can have ends that migrate between adjacent polymer layers to form adhesive-type bonds even without any covalent bonding. The selection of appropriate coating materials can reduce or eliminate hard fusing of adjacent composite particles following collection. Similarly, the coating can be modified in flight to reduce or eliminate the fusing of the particles upon collection. In-flight modification can be simply removal of solvent to reduce or eliminate mobility of coating molecules. In other embodiments, the coating composition can be crosslinked to reduce or eliminate migration of polymer strands. Other coating modifications can be performed as desired. As used herein, un-fused refers to composite particles that are substantially not hard fused, such that the particles can be subsequently dispersed relative to each other using a dispersant such as a liquid without the application of shear that can destroy the particle morphology.

Using laser pyrolysis for the formation of the inorganic core particles, the inorganic core particles can be very uniform. This uniformity of the inorganic core particles can be carried over to the composite particles. In some embodiments, the coating is formed so that the composite particles do not hard fuse, i.e., an un-agglomerated composite particle collection is formed. In some embodiments, a relatively uniform coating is applied over the uniform inorganic core particles such that the resulting composite particles have a sharp particle size distribution and essentially a lack of particles with a diameter more than a factor of four greater than the average diameter.

The in-flight modification of the particles for the assembly of composite particles can be performed in the reaction chamber where the inorganic particles are formed, and/or in a separate compartment. If multiple coating compositions are applied, one or more can be applied within the reaction chamber and/or one or more others can be applied external to the reaction chamber. Especially for coating compositions applied within the coating chamber, the coating process can be arranged to not significantly disrupt the flow with excessive turbulence or the like.

Since the inorganic core particles are produced within a flow, the in-flight modification of the particles has an inherent asymmetry and momentum changes can result from interaction of the flow with the modifying coating composition. Generally, the coating composition is sprayed to intersect the path of the product inorganic particles to present a continuous supply of coating composition along with a relatively uniform distribution of coating composition along the path of the product particles. An aerosol of coating composition can be sprayed, for example, in an orientation approximately perpendicular to the product particle flow, at a slight angle roughly along the direction of the product particle flow, at intermediate orientations relative to the above orientations, or in a mixture of directions relative to the product particle flow. An entraining gas within the product particle flow and/or introduced subsequent to product particle formation can compensate to some degree for momentum changes introduced by interaction with the modifying composition.

For embodiments in which the coating composition comprises a polymer, the polymer can be formed prior to delivery of the coating composition and/or within the spray of the coating composition. Formation of the polymer within the spray can involve light induced polymerization, heat induced polymerization, polymerization that involves spontaneous reaction upon drying of the aerosol particles and/or reaction initiated with a catalyst that is introduced into the coating composition prior to, at the time of and/or subsequent to forming the aerosol. As a more specific example, the aerosol can be subjected to a UV light that initiates a polymerization process. Also, a polymerization reaction that is initiated within a spray of coating composition may continue to completion following association of the coating composition with the inorganic particles within the flow.

Similarly, a separate coating composition assembly pathway can be used to form a coating composition in-flight. A coating composition can comprise a blend of a plurality of compositions. Processing of the coating composition in-flight can involve, for example, drying, crosslinking, polymerization, chemical modification, combinations thereof and the like. In the flow, the coating composition can take the form of a particle or droplet, which can deform or spread to form a coating over the inorganic core particle following their combination. To form composite particles comprising a polymer, a polymer formed in-flight can be combined in-flight with inorganic particles formed in a reactive flow to form desired composite particles. Specifically, the flow from the coating composition reactive channel can be intersected with flow from the inorganic product flow to form the composites, in which the intersection can be performed within the inorganic particle reaction chamber or in a separate chamber. Reactions initiated within the coating composition assembly pathway can be completed following coating onto inorganic particles. The inorganic particles in the product flow may or may not be modified in-flight prior to intersection with a coating composition flow(s).

For some embodiments with in-flight preparation of composite particles, the final collected product can comprise a plurality of types of inorganic particles. These different types of inorganic particles can have the equivalent coating as each other, different coatings with respect to different particle types and/or some of the types of inorganic particles can be uncoated. To apply an equivalent coating to different inorganic particle types, the flows with the different particle types can be combined prior to the coating process, although one or more of the individual flows of product inorganic particles may or may not be modified prior to combining the inorganic particle flows. For example, a flow of product inorganic particles or a blended flow of a plurality of inorganic particles can be surface modified or assembled into composite particles prior to combining with another flow of modified or unmodified inorganic particles.

Since a wide range of inorganic particles and coatings can be incorporated into the composite particles described herein, the composites are suitable for a wide range of applications. For example, the composite particles can be used directly as free flowing powders or for the formation of coatings on selected substrates. A significant advantage from the use of composites particles is the ability to control physical properties such as color, index-of-refraction or electronic parameters over a wide range. With respect to composite particles comprising a polymer coating, general discussion of polymer-inorganic particle composite compositions are described further U.S. Pat. No. 6,599,631 to Kambe et al., entitled “Polymer-Inorganic Particle Composites,” incorporated herein by reference and in copending U.S. patent application Ser. No. 10/083,967 to Kambe et al., entitled “Structures Incorporating Polymer-Inorganic Particle Blends,” incorporated herein by reference. Composite particles can incorporate a similar range of different compositions to achieve a similar range of properties as can be described for bulk composites incorporating inorganic nanoparticles.

In one application of interest, the particles are used as toner for application to a substrate surface using electrophotography and subsequently heated to bond the particles to the substrate surface. Composite particles with selected architectures suitable for toner applications and other applications are described further in copending and filed on the same day as the present application U.S. patent application Ser. No. 11/______ to Chiruvolu et al., entitled “NanoStructured Composite Particles and Corresponding Processes,” incorporated herein by reference. In some embodiments, the composite particles are suitable for use as pigments, which are suitable for further processing into toner particles or for a wide range of other uses. Another application is the dispersion of composite particles in a dispersant to form an ink. Such an ink forms an image following printing on a surface and the drying of the solvent. Corresponding inks can be used in a range of printing applications for both digital printing and non-digital printing applications. Due to the size and uniformity of the particles, images with sharp resolution can be formed. These inks can be used to form printable optical elements since the composite particles can be designed to have desirable optical properties. A few applications are described herein in more detail, although any suitable application is contemplated for the improved composite particles.

Apparatus

A reaction apparatus for in-flight processing accommodates a flow path that provides for a reaction to form the inorganic particles as well as for application of a coating composition and/or for the application of radiation to the flow following formation of the inorganic particle. A reactant delivery portion initiates a flow comprising precursors for the formation of the inorganic particles. Also, the reaction apparatus generally interfaces with auxiliary systems, such as systems to delivery a coating composition and/or radiation to the flow within the reaction system. Once, the final modified inorganic particles are formed, a collector separates the product modified inorganic particles from the flow to terminate the in-flight process. The distinct steps for the formation of the ultimate modified inorganic particles can be performed in the same compartment, in a separate compartment for each step, or in a plurality of compartments with multiple steps performed in one or more compartments. However, regardless of the particular reactor design, the apparatus generally is configured to synthesize inorganic particles from appropriate precursors and to modify the inorganic particles in-flight.

As described above, flow relates to a net movement of mass from one point to another. Generally, the flow path within the apparatus relating to in-flight processing extends from one or more inorganic particle reactant precursor inlets to the collector. Along the flow, the inorganic particles are synthesized and the inorganic particles are modified. Generally, a negative pressure device is used to maintain the flow through the apparatus along the flow path, although flow can be maintained from the positive pressure generated form composition delivery into the apparatus. Suitable negative pressure devices include, for example, a pump, a blower, an aspirator/venturi, compressor, ejector or the like. If there is a plurality of inorganic particle precursor inlets, flow from these can be combined either prior to inorganic particle production and/or after inorganic particle such that there are different flow of product inorganic particles. If different flows are combined, these are different branches of a flow path that combine along a flow path to a collector.

In some embodiments, the apparatuses are designed for the performance of laser pyrolysis for the formation of the core inorganic particles. Laser pyrolysis has become the standard terminology for flowing chemical reactions driven by an intense radiation, e.g., light, with rapid quenching of product inorganic particles after leaving a reaction region formed by the radiation intersecting with the reactant flow. The name, however, is a misnomer in the sense that radiation from non-laser sources, such as a strong, incoherent light or other electromagnetic beam, can replace the laser. Also, the reaction is not a pyrolysis in the sense of a thermal pyrolysis. The laser pyrolysis reaction is not solely thermally driven by the exothermic combustion of the reactants. In fact, in some embodiments, laser pyrolysis reactions can be conducted under conditions where no visible light emissions are observed from the reaction, in stark contrast with pyrolytic flames.

The reaction conditions can determine the qualities of the particles produced by laser pyrolysis. The reaction conditions for laser pyrolysis can be controlled relatively precisely in order to produce inorganic particles with desired properties. For example, the reaction chamber pressure, flow rates, composition and concentration of reactants, radiation intensity, radiation energy/wavelength, type and concentration of inert diluent gas or gases in the reaction stream, temperature of the reactant flow can affect the composition and other properties of the product particles, for example, by altering the time of flight of the reactants/products in the reaction zone and the quench rate. Thus, in a particular embodiment, one or more of the specific reaction conditions can be controlled. The appropriate reaction conditions to produce a certain type of particles generally depend on the design of the particular apparatus. Some general observations on the relationship between reaction conditions and the resulting particles can be made.

Increasing the light power results in increased reaction temperatures in the reaction region as well as a faster quenching rate. A rapid quenching rate tends to favor production of higher energy phases, which may not be obtained with processes near thermal equilibrium. Similarly, increasing the chamber pressure also tends to favor the production of higher energy phases. Also, increasing the concentration of the reactant serving as the oxygen source, nitrogen source, sulfur source or other secondary reactant source in the reactant stream favors the production of particles with increased amounts respectively of oxygen, nitrogen, sulfur or other secondary reactant.

Reactant velocity of the reactant gas stream is inversely related to particle size so that increasing the reactant velocity tends to result in smaller particle sizes. A significant factor in determining particle size is the concentration of product composition condensing into product particles. Reducing the concentration of condensing product compositions generally reduces the particle size. The concentration of condensing product can be controlled by dilution with non-condensing, e.g., inert, compositions or by changing the pressure with a fixed ratio of condensing product to non-condensing compositions, with a reduction in pressure generally leading to reduced concentration and a corresponding reduction in particle size and vice versa, or by combinations thereof, or by any other suitable means.

Light power during laser pyrolysis also influences the inorganic particle sizes with increased light power favoring smaller particle formation, especially for higher melting temperature materials. Also, the growth dynamics of the particles have a significant influence on the size of the resulting particles. In other words, different forms of a product composition have a tendency to form different size particles from other phases under relatively similar conditions. Similarly, under conditions at which populations of particles with different compositions are formed, each population of particles generally has its own characteristic narrow distribution of particle sizes.

Inorganic particles of interest include, for example, amorphous particles, crystalline particles, combinations thereof and mixtures thereof. Amorphous inorganic particles possess short-range order that can be very similar to that found in crystalline materials. In crystalline materials, the short-range order comprises the building blocks of the long-range order that distinguishes crystalline and amorphous materials. In other words, translational symmetry of the short-range order building blocks found in amorphous materials creates long-range order that defines a crystalline lattice. In general, the crystalline form is a lower energy state than the analogous amorphous form. This provides a driving force towards formation of long-range order. In other words, given sufficient atomic mobility and time, long-range order can form. For convenience, the structures of the inorganic particles are referred to as mineral structures to distinguish these materials from the coating materials, which are referred to as having non-mineral structures, although the inorganic particles do not necessarily have structures corresponding to natural minerals.

In laser pyrolysis, a wide range of inorganic particles can be formed in the reactive process. Based on kinetic principles, higher quench rates favor amorphous particle formation while slower quench rates favor crystalline particle formation as there is time for long-range order to develop. Faster quenches can be accomplished with a faster reactant stream velocity through the reaction zone. In addition, some precursors may favor the production of amorphous particles while other precursors favor the production of crystalline particles of similar or equivalent stoichiometry. The formation of amorphous metal oxides particles and crystalline metal oxide particles with laser pyrolysis is described further in U.S. Pat. No. 6,106,798 to Kambe et al., entitled “Vanadium Oxide Nanoparticles,” incorporated herein by reference.

To form a desired composition in the reaction process, one or more precursors generally supply the one or more metal/metalloid elements that are within the desired composition. The reactant stream generally would comprise the desired metal element(s) and, additionally or alternatively, metalloid element(s) to form the host material and, optionally, dopant(s)/additive(s) in appropriate proportions to produce product particles with a desired composition. Furthermore, additional appropriate precursor(s)/reactant(s) can supply other element(s) for incorporation into the product inorganic particles. The composition of the reactant stream can be adjusted along with the reaction condition(s) to generate desired product particles with respect to composition and structure. Based on the particular reactants and reaction conditions, the product particles may not have the same proportions of metal/metalloid elements as the reactant stream since the elements may have different efficiencies of incorporation into the particles, i.e., yields with respect to unreacted materials. However, the amount of incorporation of each element is a function of the amount of that element in the reactant flow, and the efficiency of incorporation can be empirically evaluated based on the teachings herein to obtain desired compositions. The designs of the reactant nozzles for radiation driven reactions described herein are designed for high yields with high reactant flows.

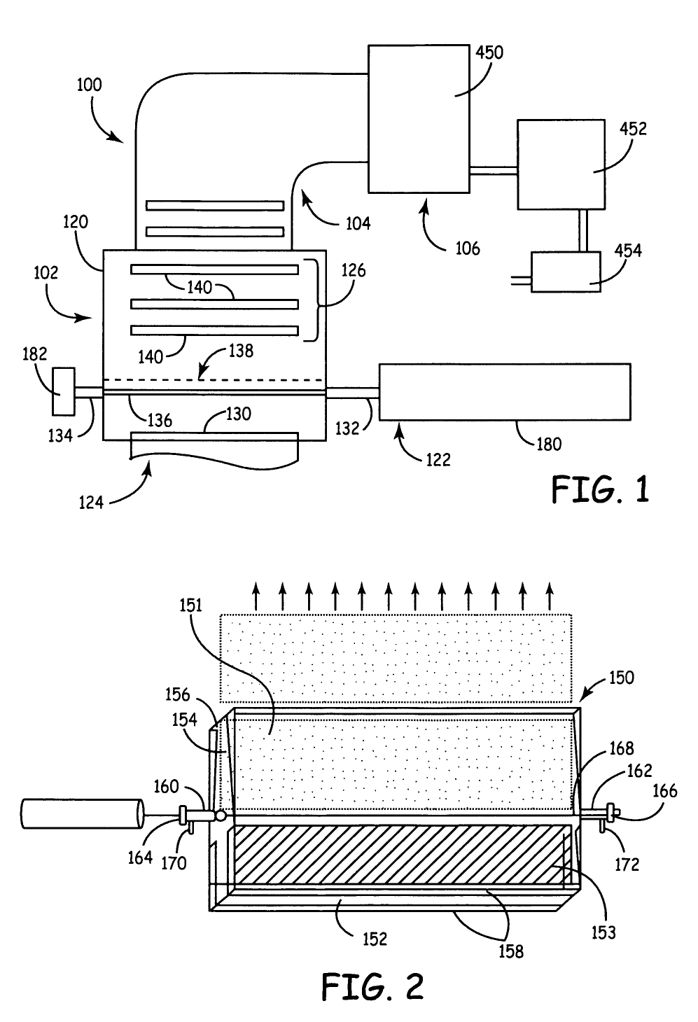

Referring to FIG. 1, modified inorganic particle production system 100 comprises a laser pyrolysis section 102, flow/modification section 104, and collection system 106. Laser pyrolysis section 102 comprises a reaction chamber 120, an intense light delivery apparatus 122, a reactant delivery portion 124 and an optional particle modifying section 126. Reaction chamber 120 confines the reaction for the formation of the inorganic core particles. Reaction chamber 120 comprises a reactant inlet 130, a light inlet conduit 132, a light outlet conduit 134 which forms a light beam path 136 with light beam inlet 132, a reaction zone 138 in the vicinity of and generally overlapping with the intersection of a light beam path 136 and the flow path of reactants from reactant inlet 130. Reaction chamber 120 can interface with particle modification section 126 at one and/or more modification elements 140, which can be coating composition nozzles or radiation sources. Appropriate flame reactors, thermal reactors or other flow based inorganic particle synthesis reactors can be constructed for in-flight modification of synthesized inorganic particles by a person of ordinary skill in the art based on the disclosure herein.

Laser pyrolysis systems suitable for producing commercial quantities of product particles can have an inlet elongated along the direction of the light beam propagation such that a sheet of reactants flow into the reaction zone to form a sheet of product particle in a product flow. Generally, essentially the entire reactant flow passes through the light beam. Large throughputs are achievable with these systems, which are able to efficiently produce high quality particles over appropriately long run time. Reaction chamber designs for large throughputs are described further in U.S. Pat. No. 5,958,348 to Bi et al., entitled “Efficient Production of Particles By Chemical Reaction,” incorporated herein by reference.

A diagram of a high throughput laser pyrolysis reaction chamber is shown schematically in FIG. 2, which has an elongated reaction chamber 150 for generating a sheet of product flow 151 from a sheet of reactant flow 153. This chamber is shown without displaying any coating components for simplicity with respect to other reactor components and can be adapted for modifying the product inorganic particles in-flight, as described further below with respect to other embodiments. A reactant inlet 152 leads to main chamber 154. Reactant inlet 152 conforms generally to the shape of main chamber 154. Reactant inlet 152 is generally connected to a reactant delivery portion. Main chamber 154 comprises an outlet 156 along the reactant/product stream for removal of the flow with product particles, any unreacted gases and inert gases. Shielding gas inlets 158 can be located on both sides of reactant inlet 152. Shielding gas inlets are used to form a blanket of inert gases on the sides of the reactant stream to inhibit contact between the chamber walls and the reactants or products.

The dimensions of elongated reaction chamber 154 and reactant inlet 152 can be designed for highly efficiency product composition production. The reaction zone is located within the reaction chamber in the vicinity of the intersection of the reactant flow with the light beam path. Reasonable elongated dimensions or widths for reactant inlet 152, when used with a CO₂ laser with a power in the several kilowatt range, are from about 5 mm to about 2 meters or in further embodiments from about 2 centimeters to about 1 meter. In general, the inlet generally has a thickness from about 1 mm to about 10 centimeters (cm) and in further embodiments from about 2 mm to about 2 cm. Furthermore, the aspect ratio of the inlet opening, which is the width divided by the thickness, can range from about 2 to about 1000 and in other embodiments from about 5 to about 200. A person of ordinary skill in the art will realize that additional ranges of inlet dimensions and aspect ratios are contemplated and are within the present disclosure. While shown as a rectangular inlet, the edges and corners can be rounded somewhat while maintaining the general nature of an elongated flow. The resulting flows through the system have dimensions reflecting the initial reactant flow, although spreading can expand the flow and shielding gas and baffles can be used to limit spreading and/or further constrain the flow. In alternative embodiments, a circular inlet can be used, which can be suitable for flame reactors and thermal reactors. Alternative configurations for high throughput laser pyrolysis, which can be adapted for in flight modification of the inorganic particles, are described in Published U.S. Patent Application 2005/020036 to Mosso et al., entitled “Particle Production Apparatus,” incorporated herein by reference.

Referring to FIG. 2, tubular sections 160, 162 extend from the main chamber 154. Tubular sections 160, 162 hold windows 164, 166, respectively, to define a light beam path 168 through the reaction chamber 150. Tubular sections 160, 162 can comprise inert gas inlets 170, 172 for the introduction of inert gas into tubular sections 160, 162. Inert gas inlets 170, 172 generally are connected to a suitable inert gas source.

Referring to FIG. 1, intense light delivery apparatus 122 generally can comprise an intense light source 180 and suitable optics, which are connected to light inlet conduit 132. A beam dump 182 can be connected to light outlet conduit 134 to terminate the light beam path. Laser pyrolysis can be performed with a variety of optical frequencies, using either a laser or other intense radiation source, such as a focused arc lamp. Some desirable light sources operate in the infrared portion of the electromagnetic spectrum, although other wavelengths can be used, such as the visible or ultraviolet regions of the spectrum. Excimer lasers can be used as intense ultraviolet light sources. CO₂ lasers are particularly convenient sources of light. Commercial CO₂ lasers are available in the watt to many kilowatts ranges. Suitable beam dumps/power meters are also commercially available. Light delivery apparatus 122 can further comprise suitable optical components, such as mirrors, lenses, widows and the like. In particular, the light inlet path from intense light source 180 into reaction chamber 120 can comprise a cylindrical lens that focuses the light in one dimension, generally the dimension along the flow of the reactants, such that in the beam is thinner in the dimension shown in FIG. 1 along the flow of reactants from the bottom of the page toward the top of the page. In the embodiment of FIG. 1 with a cylindrical lens, the beam would not be focused perpendicular to the plane of the page so that a thicker flow of reactants can pass through the light beam to increase throughput.

Reactant delivery portion 124 is configured to interface with reactant inlet 130 to deliver a flow of reactants into reaction chamber 120. Reactant delivery portion 124 can comprise suitable reservoirs, nozzles, injectors and the like to deliver gaseous reactants, vapor reactants, aerosol reactants or a combination thereof. Many precursor compositions, such as metal/metalloid precursor compositions, can be delivered into the reaction chamber as a gas/vapor. Appropriate precursor compositions for gaseous delivery generally include compositions with reasonable vapor pressures, i.e., vapor pressures sufficient to get desired amounts of precursor gas/vapor into the reactant stream. The vessel holding liquid or solid precursor compositions can be heated (cooled) to increase (decrease) the vapor pressure of the precursor, if desired. Solid precursors generally are heated to produce a sufficient vapor pressure. A carrier gas can be bubbled through a liquid precursor to facilitate delivery of a desired amount of precursor vapor. Similarly, a carrier gas can be passed over the solid precursor to facilitate delivery of the precursor vapor. Alternatively or additionally, a liquid precursor can be directed to a flash evaporator to supply a composition at a selected vapor pressure. The use of a flash evaporator to control the flow of non-gaseous precursors can provide a high level of control on the precursor delivery into the reaction chamber.

However, the use of exclusively gas/vapor phase reactants can be challenging with respect to the types of precursor compositions that can be used conveniently. Thus, techniques have been developed to introduce aerosols containing precursors, such as metal/metalloid precursors, into laser pyrolysis chambers. Improved aerosol delivery apparatuses for flowing reaction systems are described further in U.S. Pat. No. 6,193,936 to Gardner et al., entitled “Reactant Delivery Apparatuses,” incorporated herein by reference. In some embodiments, the aerosol is entrained in a gas flow, which can comprise an inert gas(es) and/or a gaseous reactant(s). Suitable aerosol generators generally include, for example, ultrasonic nozzle, an electrostatic spray system, a pressure-flow atomizer, an effervescent atomizer, a gas atomizer, a pressure flow atomizer, a spill-return atomizer, a gas-blast atomizer, a two fluid internal mix atomizer, a simplex atomizer, a two fluid external mix atomizer, a Venturi-based atomizer or combination thereof. Ultrasonic nozzles with atomization surfaces and suitable broadband ultrasonic generators are available from Sono-Tek Corporation, Milton, N.Y., such as model 8700-120. Suitable gas atomizers are available from Spraying Systems, Wheaton, Ill.

For embodiments involving a plurality of metal/metalloid elements, the metal/metalloid elements can be delivered all as vapor, all as aerosol or as any combination thereof. If a plurality of metal/metalloid elements is delivered as an aerosol, the precursors can be dissolved/dispersed within a single solvent/dispersant for delivery into the reactant flow as a single aerosol. Alternatively, the plurality of metal/metalloid elements can be delivered within a plurality of solutions/dispersions that are separately formed into an aerosol. The generation of a plurality of aerosols can be helpful if convenient precursors are not readily soluble/dispersible in a common solvent/dispersant. The plurality of aerosols can be introduced into a common gas flow for delivery into the reaction chamber through a common nozzle. Alternatively, a plurality of reactant inlets can be used for the separate delivery of aerosol and/or vapor reactants into the reaction chamber such that the reactants mix within the reaction chamber prior to entry into the reaction zone. Multiple reactant inlets for delivery into a laser pyrolysis chamber are described further in copending U.S. patent application Ser. No. 09/970,279 to Reitz et al., entitled “Multiple Reactant Nozzle For A Flowing Reactor,” incorporated herein by reference.

In addition, for the production of highly pure materials, it may be desirable to use a combination of vapor and aerosol reactants. In some embodiments, vapor/gas reactants generally can be supplied at higher purity than is readily available at low cost for aerosol delivered compositions. At the same time, some elements, especially rare earth dopant(s)/additive(s), alkali metals and alkali earth metals as well as some transition metals, cannot be conveniently delivered in vapor form. Thus, in some embodiments, a majority of the material for the product compositions can be delivered in vapor/gas form while other elements are delivered in the form of an aerosol. The vapor and aerosol can be combined for reaction, for example, prior to introduction into the reaction chamber and/or following delivery through a single reactant inlet or a plurality of inlets into the reaction chamber.

Also, secondary reactants can be used in some embodiments to alter the oxidizing/reducing conditions within the reaction chamber and/or to contribute non-metal/metalloid elements or a portion thereof to the reaction products. The particles, in some embodiments, further comprise one or more non-(metal/metalloid) elements. For example, some compositions of interest are oxides, nitrides, carbides, sulfides or combinations thereof. For the formation of oxides, an oxygen source should also be present in the reactant stream, and other appropriate sources of non-(metal/metalloid) elements can be supplied to form the other compositions.

Suitable secondary reactants serving as an oxygen source for the formation of oxides include, for example, O₂, CO, N₂O, H₂O, CO₂, O₃ and the like and mixtures thereof. Molecular oxygen can be supplied as air. In some embodiments, the metal/metalloid precursor compositions comprise oxygen such that all or a portion of the oxygen in product particles is contributed by the metal/metalloid precursors. Similarly, liquids used as a solvent/dispersant for aerosol delivery can similarly contribute secondary reactants, e.g., oxygen, to the reaction. In other words, if one or more metal/metalloid precursors comprise oxygen and/or if a solvent/dispersant comprises oxygen, a separate secondary reactant, e.g., a vapor reactant, may not be needed to supply oxygen for product particles. The conditions in the reactor should be sufficiently oxidizing to produce the metal/metalloid oxide particles.

Generally, a secondary reactant composition should not react significantly with the metal/metalloid precursor(s) prior to entering the radiation reaction zone since this can result in the formation of larger particles and/or damage the inlet nozzle. Similarly, if a plurality of metal/metalloid precursors is used, these precursors should not significantly react prior to entering the radiation reaction zone. If the reactants are spontaneously reactive, a metal/metalloid precursor and the secondary reactant and/or different metal/metalloid precursors can be delivered in separate reactant inlets or nozzles into the reaction chamber such that they are combined just prior to reaching the light beam.

Infrared absorber(s) for inclusion in the reactant stream include, for example, C₂H₄, isopropyl alcohol, NH₃, SF₆, SiH₄ and O₃. O₃ and isopropyl alcohol can act as both an infrared absorber and as an oxygen source. The radiation absorber(s), such as the infrared absorber(s), can absorb energy from the radiation beam and distribute the energy to the other reactants to drive the pyrolysis.

An inert shielding gas can be used to reduce the amount of reactant and product molecules contacting the reactant chamber components. Inert gases can also be introduced into the reactant stream as a carrier gas and/or as a reaction moderator. Appropriate inert gases generally include, for example, Ar, He, N₂ (for many reactions), other gases suitably inert for particular reactions, or combinations thereof.

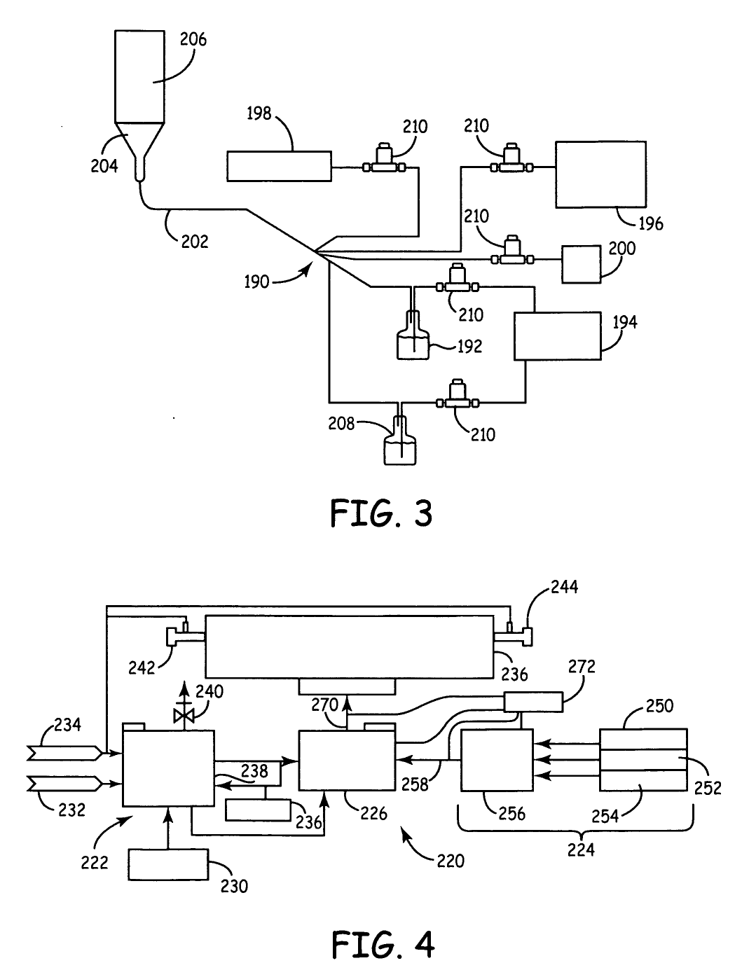

An embodiment of a reactant delivery unit suitable for the delivery of vapor reactants to reactant inlet 130 of FIG. 1 is shown schematically in FIG. 3. Referring to FIG. 3, a reactant delivery unit 190 comprises a source 192 of a precursor compound, which can be a liquid, solid or gas. For liquid or solid reactants, an optional carrier gas from one or more carrier gas sources 194 can be introduced into precursor source 192 to facilitate delivery of the reactant. Precursor source 192 can be a liquid holding container, a solid precursor delivery apparatus or other suitable container. The carrier gas from carrier gas source 194 can be, for example, an infrared absorber, a secondary reactant, an inert gas or mixtures thereof. In alternative embodiments, precursor source 192 is a flash evaporator that can deliver a selected vapor pressure of precursor without necessarily using a carrier gas. A flash evaporator can deliver a selected partial pressure of a precursor vapor into the reaction chamber, and other components leading to the reaction chamber can be heated, if appropriate, to reduce or eliminate condensation of the vapor prior to entry into the reaction chamber. Thus, a plurality of flash evaporators can be used to deliver selected amounts of a plurality of vapor reactants into the reaction chamber.

The gases/vapors from precursor source 192 can be mixed with gases from infrared absorber source 196, inert gas source 198 and/or gaseous reactant source 200 by combining the gases/vapors in a single portion of tubing 202. The gases/vapors are combined a sufficient distance from the reaction chamber such that the gases/vapors become well mixed prior to their entrance into the reaction chamber. The combined gas/vapor in tube 202 passes through a duct 204 into channel 206, which is in fluid communication with a reactant inlet, such as 130 in FIG. 1.

An additional reactant precursor can be supplied as a vapor/gas from second reactant source 208, which can be a liquid reactant delivery apparatus, a solid reactant delivery apparatus, a flash evaporator, a gas cylinder or other suitable container or containers. As shown in FIG. 3, second reactant source 208 delivers an additional reactant to duct 204 by way of tube 202. Alternatively, second reactant source can deliver the second reactant into a second duct such that the two reactants are delivered separately into the reaction chamber where the reactants combine at or near the reaction zone. Thus, for the formation of complex materials and/or doped materials, a significant number of reactant sources and, optionally, separate reactant ducts can be used for reactant/precursor delivery. For example, as many as 25 reactant sources and/or ducts are contemplated, although in principle, even larger numbers could be used. Mass flow controllers 210 can be used to regulate the flow of gases/vapors within the reactant delivery system of FIG. 3.

An alternative embodiment of a reactant delivery unit is shown schematically in FIG. 4. As shown in FIG. 4, reactant delivery unit 220 comprises a gas delivery subsystem 222 and a vapor delivery subsystem 224 that both join a mixing subsystem 226. Gas delivery subsystem 222 can comprise one or more gas sources, such as a gas cylinder or the like for the delivery of gases into the reaction chamber. As shown in FIG. 4, gas delivery subsystem 222 comprises precursor gas sources 230, 232, 234, and an optional light absorbing gas source 236, which can supply a light absorbing gas for laser pyrolysis if a reaction precursor does not sufficiently absorb the intense light. In other embodiments, the gas delivery subsystem can comprise a different number of gas sources such that desired precursors can be selected as desired. The gases combine in a gas manifold 238 where the gases can mix. Gas manifold can have a pressure relief valve 240 for safety. Inert gas source 234 can be also used to supply inert gas within the chamber adjacent the windows/lenses 242, 234 used to direct light from an external light source into chamber 236.

Vapor delivery subsystem 224 comprises a plurality of flash evaporators 250, 252, 254. Although shown with three flash evaporators, vapor delivery subsystem can comprise, for example, one flash evaporator, two flash evaporators, four flash evaporators or more than four flash evaporators to provide a desired number of vapor precursors that can be selected for delivery into the reactor to form desired inorganic particles. Each flash evaporator can be connected to a liquid reservoir to supply liquid precursor in suitable quantities. Suitable flash evaporators are available from, for example, MKS Equipment or can be constructed from readily available components. The flash evaporators can be programmed to deliver a selected partial pressure of the particular precursor. The vapors from the flash evaporator are directed to a manifold 256 that directs the vapors to a common feed line 258. The vapor precursors mix within common feed line 258.

The gas components from gas delivery subsystem 222 and vapor components from vapor delivery subsystem 224 are combined within mixing subsystem 226. Mixing subsystem 226 can be a manifold that combines the flow from gas delivery subsystem 222 and vapor delivery subsystem 224. In the mixing subsystem 226, the inputs can be oriented to improve mixing of the combined flows of different vapors and gases at different pressures. The mixing block can have a slanted termination to reduce backflow into lower pressure sources. A conduit 270 leads from mixing subsystem 226 to reaction chamber 236. Reactant delivery unit 220 can be configured to deliver a selected reactant composition based on a supply with a range of precursors and other reactants to tune a particular inorganic particle composition without refitting the unit since a number of precursors supplies can be integrated together within the unit simultaneously.

Referring to FIG. 4, a heat controller 272 can be used to control the temperature of various components through conduction heaters or the like throughout the vapor delivery subsystem, mixing subsystem 226 and conduit 270 to reduce or eliminate any condensation of precursor vapors. A suitable heat controller is model CN132 from Omega Engineering (Stamford, Conn.). Overall precursor flow can be controlled/monitored by a DX5 controller from United Instruments (Westbury, N.Y.). The DX5 instrument can be interfaced with mass flow controllers (Mykrolis Corp., Billerica, Mass.) controlling the flow of one or more vapor/gas precursors. The automation of the unit can be integrated with a controller from Brooks-PRI Automation (Chelmsford, Mass.).

As noted above, the reactant stream can comprise one or more aerosols. The aerosols can be formed within the reaction chamber or outside of the reaction chamber prior to injection into the reaction chamber. If the aerosols are produced prior to injection into the reaction chamber, the aerosols can be introduced through reactant inlets comparable to those used for gaseous/vapor reactants. For the formation of inorganic particles with complex compositions, additional aerosol generators and/or vapor/gas sources can be combined to supply the desired precursor compositions within the reactant stream.

Using aerosol delivery apparatuses, solid precursor compositions can be delivered by dissolving the compositions in a solvent. Alternatively, powdered precursor compositions can be dispersed in a liquid/solvent for aerosol delivery. Liquid precursor compositions can be delivered as an aerosol from a neat liquid, a multiple liquid dispersion or a liquid solution. Aerosol reactants can be used to obtain a significant reactant throughput. A solvent/dispersant can be selected to achieve desired properties of the resulting solution/dispersion. Suitable solvents/dispersants include water, methanol, ethanol, isopropyl alcohol, other organic solvents, metal/metalloid precursors themselves and mixtures thereof. The solvent should have a desired level of purity such that the resulting particles have a desired purity level. Some solvents, such as isopropyl alcohol, are significant absorbers of infrared light from a CO₂ laser such that no additional light absorbing composition may be needed within the reactant stream if a CO₂ laser is used as a light source.

The precursor compositions for aerosol delivery are dissolved in a solution generally with a concentration in the range(s) greater than about 0.1 molar. Generally, increasing the concentration of precursor in the solution increases the throughput of reactant through the reaction chamber. As the concentration increases, however, the solution can become more viscous such that the aerosol may have droplets with larger sizes than desired. Heating the solution can increase solubility and lower the viscosity to increase production rate without increasing aerosol droplet size. Thus, selection of solution concentration can involve a balance of factors in the selection of a suitable solution concentration.

If precursors are delivered as an aerosol with a solvent present, the solvent generally can be rapidly evaporated by the radiation (e.g., light) beam in the reaction chamber such that a gas phase reaction can take place. In addition, solvent generally can also evaporate prior to reaching the light beam during delivery. Under appropriate conditions, the resulting particles may not be highly porous, in contrast to other approaches based on aerosols in which the solvent cannot be driven off rapidly. Thus, the fundamental features of the laser pyrolysis reaction can be essentially unchanged by the presence of an aerosol. Nevertheless, the reaction conditions are affected by the presence of the aerosol. The use of aerosol reactants for laser pyrolysis particle production is described further in U.S. Pat. No. 6,849,334 to Home et al., entitled “Optical Materials And Optical Devices,” incorporated herein by reference.

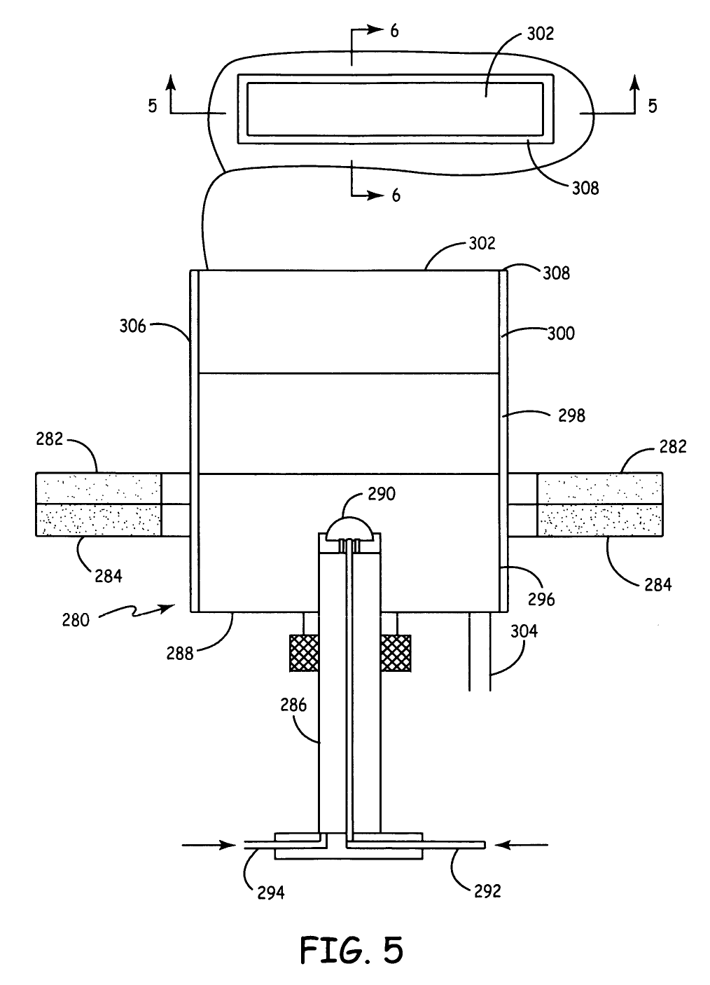

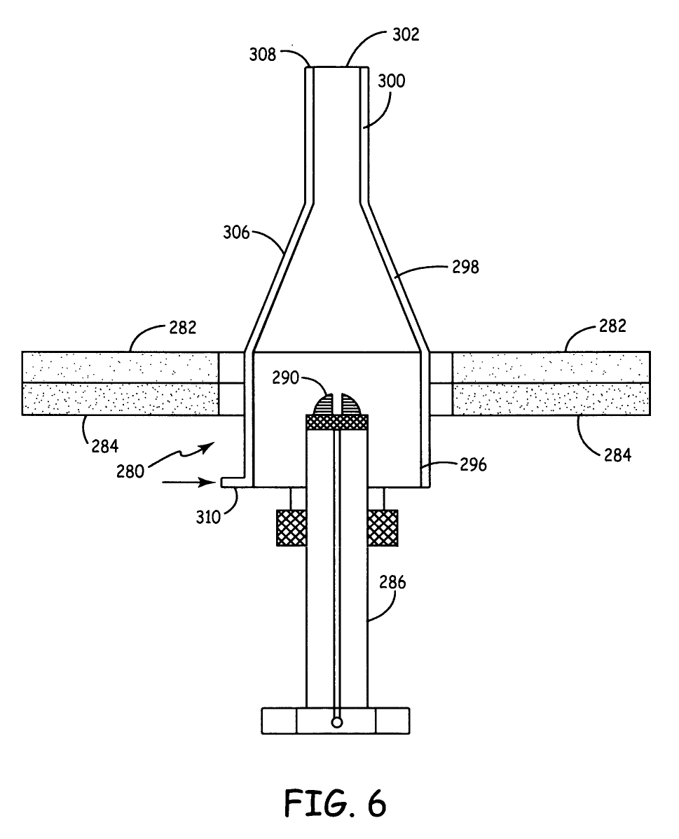

An embodiment of a reactant delivery nozzle configured to deliver an aerosol reactant along with gas/vapor is shown in FIGS. 5 and 6. Inlet nozzle 280 connects with a reaction chamber at its lower surface 282. Inlet nozzle 280 comprises a plate 284 that bolts into lower surface 282 to secure inlet nozzle 280 to the reaction chamber. Inlet nozzle 280 comprises an inner nozzle 286 and an outer nozzle 288. Inner nozzle 286 can have, for example, a twin orifice internal mix atomizer 290 at the top of the nozzle. Suitable gas atomizers are available from Spraying Systems, Wheaton, Ill. The twin orifice internal mix atomizer 290 has a fan shape to produce a thin sheet of aerosol and gaseous compositions. Liquid is fed to the atomizer through tube 292, and gases for introduction into the reaction chamber are fed to the atomizer through tube 294. Interaction of the gas with the liquid assists with droplet formation.

Outer nozzle 288 comprises a chamber section 296, a funnel section 298 and a delivery section 300. Chamber section 296 holds the atomizer of inner nozzle 286. Funnel section 298 directs the aerosol and gaseous compositions into delivery section 300. Delivery section 300 leads to a rectangular reactant opening 302, shown in the insert of FIG. 5. Reactant opening 302 forms a reactant inlet into a reaction chamber for laser pyrolysis. Outer nozzle 288 comprises a drain 304 to remove any liquid that collects in the outer nozzle. Outer nozzle 288 is covered by an outer wall 306 that forms a shielding gas opening 308 surrounding reactant opening 302. Inert shielding gas is introduced through tube 310. Additional embodiments for the introduction of an aerosol with one or more aerosol generators into an elongated reaction chamber is described in U.S. Pat. No. 6,193,936 to Gardner et al., entitled “Reactant Delivery Apparatuses,” incorporated herein by reference.

For the performance of laser pyrolysis, the energy absorbed from the light beam increases the temperature at a tremendous rate, many times the rate that heat generally would be produced by exothermic reactions under controlled condition(s). While the process generally involves nonequilibrium conditions, the temperature can be described approximately based on the energy in the absorbing region. The laser pyrolysis process is qualitatively different from the process in a combustion reactor where an energy source initiates a reaction, but the reaction is driven by energy given off by an exothermic reaction. Thus, while the light driven process for particle collection is referred to as laser pyrolysis, it is not a traditional pyrolysis since the reaction is not driven by energy given off by the reaction but by energy absorbed from a radiation beam. In particular, spontaneous reaction of the reactants generally does not proceed significantly, if at all, back down the reactant flow toward the nozzle from the intersection of the radiation beam with the reactant stream. If necessary, the flow can be modified such that the reaction zone remains confined.

With suitable high throughput reactor designs, high inorganic particle production rates can be achieved. The particle production rate based on reactant delivery configurations described herein can yield particle production rates in the range(s) of at least about 0.1 g/h, in some embodiments at least about 10 g/h, in some embodiments at least about 50 g/h, in other embodiments in the range(s) of at least about 100 g/h, in further embodiments in the range(s) of at least about 250 g/h, in additional embodiments in the range(s) of at least about 1 kilogram per hour (kg/h) and in general up in the range(s) up to at least about 10 kg/h. A person of ordinary skill in the art will recognize that additional values of particle production rate within these specific values are contemplated and are within the present disclosure.

In general, these high production rates can be achieved while obtaining relatively high reaction yields, as evaluated by the portion of metal/metalloid nuclei in the flow that are incorporated into the product inorganic particles. In general, the yield can be in the range(s) of at least about 30 percent based on the limiting reactant, in other embodiments in the range(s) of at least about 50 percent, in further embodiments in the range(s) of at least about 65 percent, in other embodiments in the range(s) of at least about 80 percent and in additional embodiments in the range(s) of at least about 95 percent based on the metal/metalloid nuclei in the reactant flow. A person of ordinary skill in the art will recognize that additional values of yield within these specific values are contemplated and are within the present disclosure.

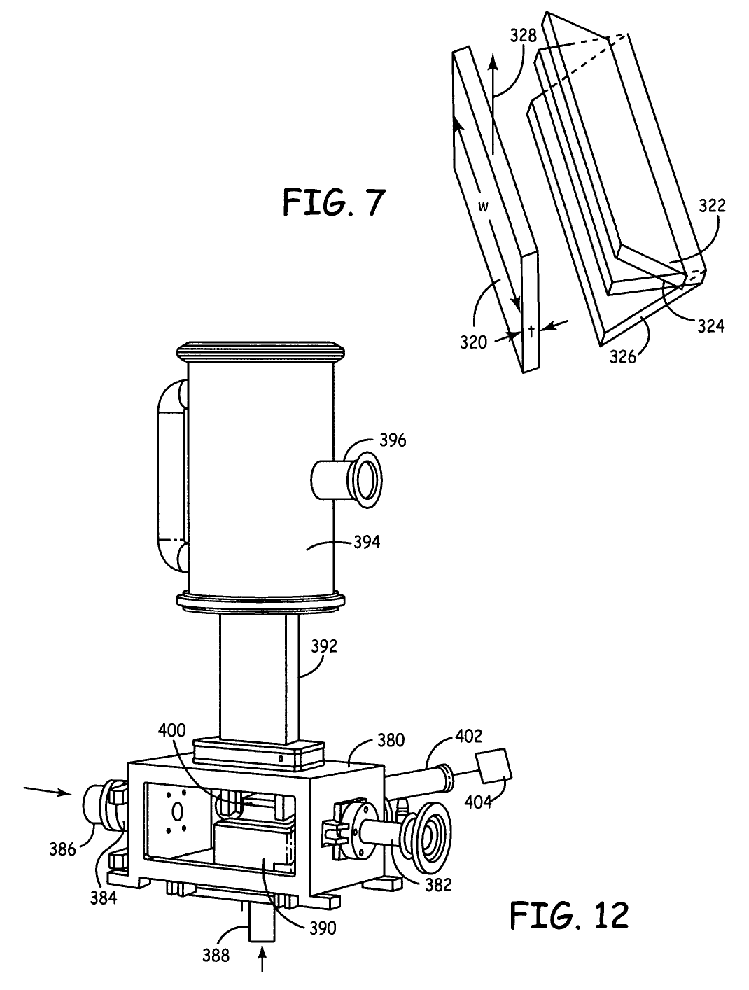

Referring to FIG. 1, particle modification section 126 can comprise one or more modification elements 140, each of which can be a coating nozzle or a radiation source. Coating nozzles can be operably connected to a coating composition supply system. A coating nozzle can be oriented to deliver the coating composition with a desired momentum to the flow with product inorganic particles. This is shown schematically in FIG. 7 with a sheet of inorganic particle reaction product flow. A product flow of inorganic particles 320 can have a cross sectional width “w” and a thickness “t” resulting in an aspect ratio of w/t for a cross section of the flow. The dimensions of the product flow relate back to the shape of the inorganic precursor reactant inlet, which can be referenced as a specific feature of the apparatus, although the product flow may involve some spreading or other alteration of the flow.

Three different coating nozzle embodiments 322, 324, 326 are superimposed for comparison in FIG. 7. Nozzle 322 is oriented to deliver a coating composition with an average momentum component along the inorganic particle product flow indicated with a flow arrow 328. Nozzle 324 is oriented to deliver a coating composition with an average momentum component perpendicular to the average flow direction of the inorganic particle product flow. Nozzle 326 is oriented to deliver a coating composition with an average momentum component against the average flow direction of the inorganic particle product flow to generate a larger relative momentum between the two flows. Other configurations in addition to the representative embodiments in FIG. 7 can be used as appropriate. In general, for any processing steps involving the combination of flows from different sources, the flow can be controlled to avoid the introduction of excessive turbulence that can destabilize the flow in undesirable ways.

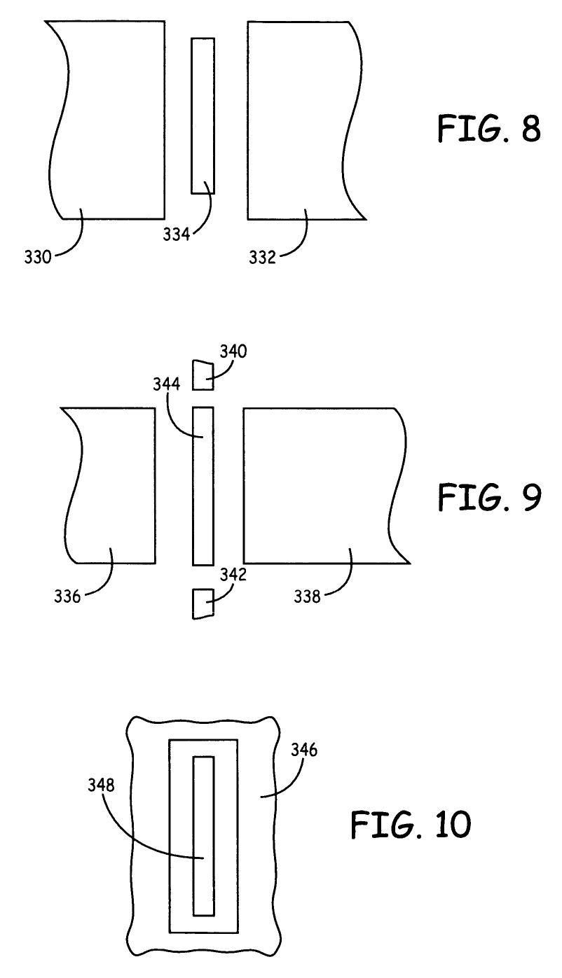

It may be desirable to have a more symmetrical coating composition delivery with any of the orientations in FIG. 7 or with other orientations. Referring to a top sectional view in FIG. 8, a coating composition inlet has two nozzle components 330, 332 disposed on the two sides of product inorganic particle flow 334. Nozzle components 330, 332 can have a width somewhat larger than the width of inorganic particle flow 334 to reduce any edge effects. Another embodiment is shown in FIG. 9. In this embodiment, coating composition inlet has four nozzle components 336, 338, 340, 342 with nozzle components 336, 338 along the face of the inorganic particle sheet 344 and nozzle components 340, 342 along the edges of the inorganic particle sheet 344. The flow rates through the nozzle components can be adjusted to yield more uniform composite particles. The nozzle configuration can be generalized further to have coating composition delivered completely encircling the flow, as shown in FIG. 10 with nozzle 346 surrounding inorganic particle flow 348. Variations on these specific embodiments in FIGS. 8-10 can be used to obtain a desired level of coating uniformity.

In general, reactant delivery components suitable for the delivery of inorganic particle precursors/reactants can be adapted for the delivery of coating compositions. In particular, in some embodiments the coating composition inlet is elongated, as shown in FIGS. 7 and 8, to intersect with an elongated inorganic particle product flow. Suitable coating composition reactant delivery systems can be used for the delivery of a vapor and/or aerosol coating compositions along an elongated inlet(s). Specifically, particular embodiments of delivery systems are shown in FIGS. 3-6, which can be adapted to deliver coating compositions.

As noted above with respect to FIG. 1, particle modification section 126 can comprises one or more radiation sources that are placed to direct radiation within the reaction chamber to modify the properties of the inorganic particles and/or to modify the coating properties. Suitable radiation sources include, for example, an electron beam, a corona discharge or a source of electromagnetic radiation. Klystrons or other electron beam sources can be adapted for these applications. Suitable electromagnetic radiation can be used, such as infrared, visible, microwave, ultraviolet, x-rays and combinations thereof. Suitable light sources can be used to deliver desired wavelengths, such as ultraviolet light emitting diodes, as described in U.S. Pat. No. 6,734,033 to Emerson et al., entitled “Ultraviolet Light Emitting Diode,” incorporated herein by reference; a wide range of diodes and other light sources in the visible; infrared diodes, as described in U.S. Pat. No. 6,783,260 to Machi et al., entitled “IR Laser Based High Intensity Light,” incorporated herein by reference; and microwaves, as described in Published U.S. Patent Application 2004-0245932A to Durand, entitled “Microwave Generator With Virtual Cathode,” incorporated herein by reference. Infrared and/or microwave radiation can be used to heat the flow to evaporate solvent, induce crosslinking or other thermally driven reactions and/or induce other thermal processes. Ultraviolet light and/or visible light can be used to induce crosslinking or other specific reactions. Electron beams can be used to crosslink samples or induce other property changes.

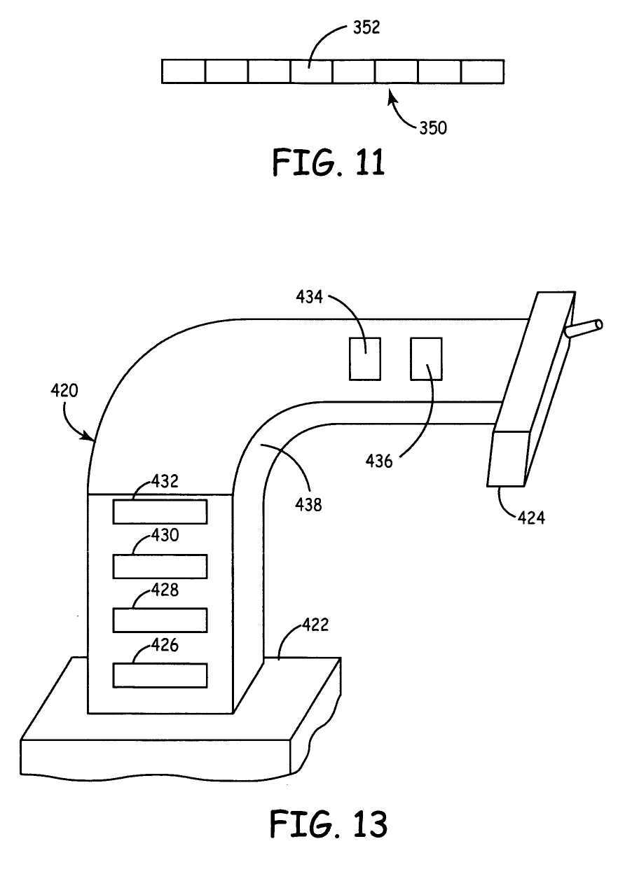

While a single element can be used for the radiation source, the radiation source can be similar configured with one or a plurality of elements roughly in a way corresponding to the coating nozzle configurations as shown in FIGS. 8-10, for the more uniform irradiation of the flow. In some embodiments, the radiation source can have an extended element or group of elements to generate radiation along an extended panel. For example, as shown in FIG. 11, a radiation emitting panel 350 can comprise a plurality of elements 352, which can be diodes, klystrons, or the like.

An alternative embodiment of a reaction chamber is shown in FIG. 12 with a single coating composition nozzle. Referring to FIG. 12, reaction chamber 380 comprises a light tube 382 that connects to an intense light source, such as a CO₂ laser, and a light tube 384 connected to a beam dump 386. An inlet tube 388 connects with a precursor delivery portion that delivers vapor reactants and carrier gases. Suitable reactant delivery portions are described above. Inlet tube 388 leads to reactant nozzle 390. An exhaust transport tube 392 connects to process chamber 380 along the flow direction from reactant nozzle 390. Exhaust transport tube 392 leads to a product filtration chamber 394 with a filer element. Product filtration chamber 394 connects to a vacuum pump or the like at pump connector 396. Coating nozzle 400 is configured to direct a coating composition just above a reaction zone within chamber 380. Coating nozzle 400 is operably connected to a coating composition feed line 402, which is in fluid communication with coating composition reservoir 404.

With respect to FIG. 1, if particle modification section 126 comprises a plurality of coating nozzles and/or radiation sources, each coating nozzle can be configured independently, for example, with a suitable configuration as shown in FIGS. 7-10, and each radiation source can be similarly independently configured. The spacing and relative positioning of the coating nozzles and radiation sources can be configured to yield the desired product particles. Similarly, a radiation source can be configured to irradiate the flow before or after delivery of a coating composition depending on whether or not the radiation is intended to alter the properties or induce reaction of the coating compositions.

As a specific example, we can assume as a representative example, that the three modification elements 140 are two coating nozzles and one radiation source. The radiation source can be placed first along the flow to modify the inorganic particles prior to coating the particles. Alternatively, the radiation source can be placed upstream from both coating nozzles so that the radiation is directed at the particles in the flow after receiving coating materials from both coating nozzles. In another alternative configuration, the radiation source can be positioned between the two coating nozzles so that the radiation interacts with the particles after the deposition of a first coating composition but before the deposition of a second coating composition.

In summary, reaction chamber 120 of FIG. 1 is shown with three modification elements while reaction chamber 380 of FIG. 12 has a single modification element, which is a coating nozzle. Similarly, reaction chambers can have no modification elements, two modification elements, four modification or more than four modification elements. Also, each element can be a radiation source or a coating nozzle. The positioning and order of the modification elements can be selected as desired to achieve the appropriate results of the modification process. For embodiments with a plurality of coating composition delivery inlets, these can be spaced an appropriate amount within the coating chamber such that the coating processes interact with each other to a selected degree. Also, an apparatus with a fixed number and position of modification elements can be reconfigured for different coating compositions and/or radiation sources for a particular desired product. With such an apparatus, each modification element may or may not be used for any particular run through the apparatus to produce desired product particles.

Referring to FIG. 1, flow/modification section 104 connects the laser pyrolysis system with the collector system. In the embodiment of FIG. 12, the flow/modification system is a conduit directing the flow to a filter based collector. If flow/modification section 104 does not comprise any modification elements, all particle modification is initiated with the reaction system, e.g., the laser pyrolysis chamber or other inorganic particle synthesis chamber. The flow/modification section 104, as with exhaust transport tube 392 of FIG. 12, then conveys the particles from the reaction chamber to the collector system without further modifying the particles. However, in other embodiments, flow/modification section 104 comprises one or more modification elements.

In particular, in some embodiments, referring to FIG. 1, flow/modification section 104 comprises one or more modification elements involved with the delivery of one or more coating compositions and/or interaction with radiation from a radiation source at one or more locations. For any of these embodiments, the flow/modification element further comprises a conduit and/or chambers. Flow/modification section 104 can be distinguished from the reaction section 102 due to a change in direction of the flow or due to a change in cross sectional area available to the flow, such as a constriction. A conduit can be straight, or it can be curved to redirect the flow as appropriate to reach the collection system. Thus, the cross sectional dimensions may or may not remain relatively constant between the inorganic particle synthesis reactor and the flow/modification section, and the conduit can have a circular cross section even if the reaction chamber flow is elongated.

For the embodiment of the particle production system in FIG. 12, flow/modification section 104 corresponds with exhaust transport tube 392. Exhaust transport tube 392 only transports particles and does not comprise elements to modify the particles. Once the modified particles exit reaction chamber 380, the particles proceed to collector without being subjected to further modification conditions.

An embodiment of a flow/modification section configured with processing stations for modifying the particles in the flow is shown in FIG. 13. Flow/modification section 420 is operably connected between inorganic particle reaction chamber 422 and collector 424. As shown in FIG. 13, flow/coating system 420 comprises 6 modification elements 426, 428, 430, 432, 434, 436 along conduit 438. Each modification element can comprise a coating composition delivery nozzle or a radiation source. Each coating delivery nozzle can be configured, for example, as described above with respect to FIGS. 7-10. Specifically, the orientation of a coating nozzle can be configured to deliver the particular coating composition with a desired momentum with respect to the flow. Similarly, the configuration of the coating composition nozzle around the flow can be designed to deliver a more uniform distribution of coating composition with a configuration of FIGS. 8-10. Each coating composition nozzle generally is in fluid communication with a coating composition supply element having a reservoir to deliver a vapor and/or aerosol comprising the desired coating composition. Suitable radiation sources are described above in detail and these can be oriented around the flow as desired, for example using the configurations shown in FIGS. 8-10. Panels of radiation source can be configured as shown in FIG. 11.

While FIG. 13 shows a flow/modification section with 6 modification elements, flow/modification sections can be configured with 1, 2, 3, 4, 5, 7, 8, 9, 10 or more modification elements. The number of modification elements, their relative positioning and the configuration of individual modification elements can be designed to achieve desired coating properties. In general, the length along the flow of the flow/coating system can be selected to provide desired space for placement of desired modification elements. Factors for consideration in selecting the order and positioning of the modification elements for placement within the reaction chamber generally are similarly relevant for evaluating the order and placement within the flow/modification section.

In addition, FIG. 13 shows flow/modification section 420 having conduit 438 with approximately constant cross section perpendicular to the flow along the conduit, although conduit 438 changes direction. However, a flow/modification section can change cross section perpendicular to the flow to accomplish particular processing objectives. For example, the flow/modification section can open into a processing chamber or taper to constrict the flow. Tapering can increase the density within the flow, which can result in some controlled agglomeration of the particles within the flow. If desired, the flow can be controlled to effectively form a fluidized bed reactor to result in further controlled agglomeration prior to collection of the particles. Directing the flow to a fluidized bed reactor is described further in copending and filed on the same day as the present application U.S. patent application Ser. No. 11/______ to Chiruvolu et al., entitled “NanoStructured Composite Particles and Corresponding Processes,” incorporated herein by reference.

As noted above, it can be desirable to add inert gas to the flow following formation of the inorganic particles. In particular, inert gas can be used to cool the inorganic particles prior to further modification, especially coating, of the particles. Similarly, inert gas can be used to cool the particles after they are irradiated within the flow. Furthermore, inert gas can be introduced to constrain the flow of the product particles and to shield the walls of the apparatus. To deliver inert gas, a coating nozzle within the reaction chamber and/or within the flow/modification section can be configured to deliver inert gas rather than a coating composition.

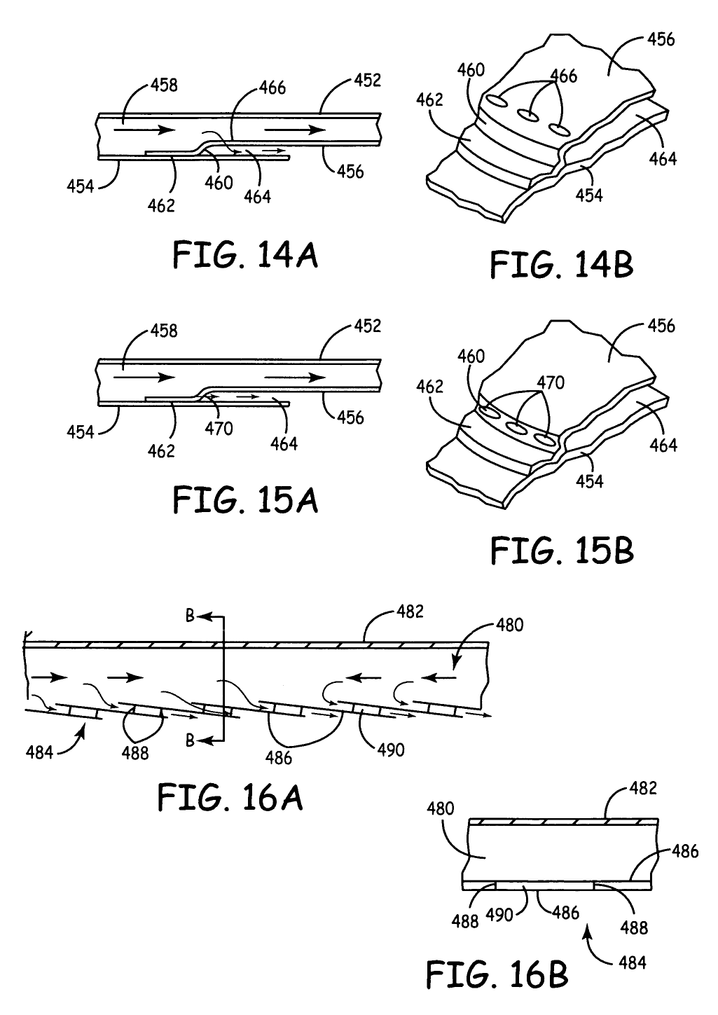

In alternative embodiments, a film of inert gas can be delivered through small openings or pores in the wall of the reaction chamber or through the walls of the flow/modification section. Furthermore, these constructions can also be used to deliver a coating composition. Representative wall modifications for the delivery of inert gas and/or modification compositions are shown in FIGS. 14-18. With respect to the figures, portions of the apparatus having fluid delivery through the walls are referred to as components, e.g., the reaction chamber or the flow/modification section.

Referring to FIGS. 14A and 14B, a first approach for thin film fluid delivery is depicted. The walls comprise an outer wall 452. The inner wall comprises two or more overlapping sections, comprising first section 454 and second section 456, which extend around the circumference of the component to form the inner wall of the particular component. First section 454 has a smaller diameter around the circumference of the wall compared with second section 456 such that they can overlap as shown in FIGS. 14 and 15. A delivery channel 458 is located between outer wall 452 and inner walls 454, 456. Delivery channel 458 is connected to a source of inert shielding gas or other fluid composition. Inner wall 456 has a bend 460 to connect to flange 462 that is welded or otherwise secured against inner wall 464. The overlapping region between inner walls 464, 466 forms a channel 464 that directs a thin film of shielding gas along inner wall 456. Fluid can pass into channel 464 through openings 466.

An alternative embodiment of a thin film system is shown in FIGS. 15A and 15B. In this embodiment, openings 470 are located along bend 460 such that shielding gas impinges on inner wall 454 to distribute flow within channel 464 so that flow is more or less uniform as it exits channel 464 along inner wall 456. While the flow arrows in FIGS. 14A and 15A indicate an overall flow within delivery channel 458 from left-to-right, the flow within delivery channel 458 can be in the opposite direction from right-to-left. The pressure in delivery channel 458 is higher than the pressure in the component such that inert gas flows into channel 464.

In FIGS. 14-15 only one film directing channel 464 extending the circumference of the component is shown. Additional film directing channels can be formed along the direction of flow within the reaction chamber using additional sections of inner wall if desired for the efficient delivery of selected fluid. These series of channels 464, each extending around the circumference of the component, can be repeated along the length of the component.

An alternative embodiment is shown in FIGS. 16A and 16B. The shielding gas delivery conduit 480 is formed by outer wall 482 and inner wall 484. Inner wall 484 is formed by a series of wall sections 486. Each wall section 486 extends around the circumference of the component. Wall sections are secured to adjacent sections by spacers 488 to form the inner wall. Shielding gas delivery channels 490 are formed between wall sections 486. The dimensions of wall sections 486 and spacers 488 are selected to yield desired dimensions for channels 490.

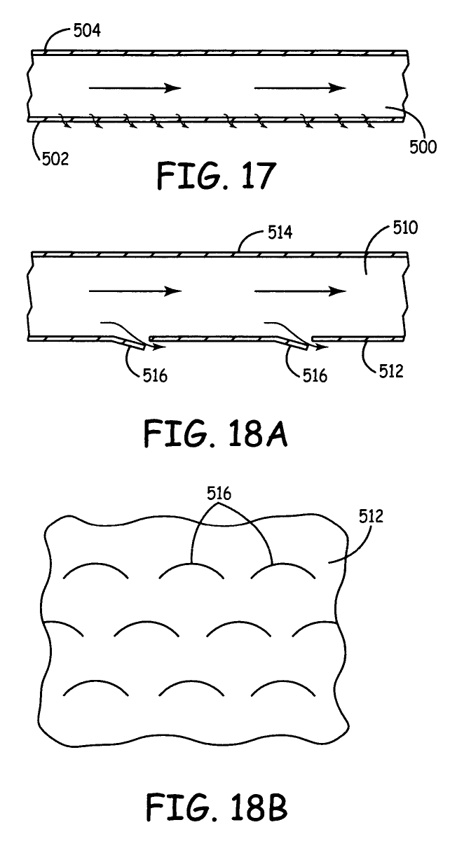

In another alternative embodiment, the chamber walls along the direction of the reactant flow comprise an inert gas channel 500 between an inner wall 502 and an outer wall 504, as shown in FIG. 17. All or a portion of inner wall 502 can be a porous metal such that fluid, such as inert gas, permeates into the interior of the component. Thus, a film of fluid lines the porous metal along the wall of the component.

In a similar embodiment, the component walls comprise an inert gas channel 510 between an inner wall 512 and an outer wall 514, as shown in FIGS. 18A and 18B. Inner wall 512 is formed from stamped metal that has louvers 516 along inner wall 512 that form openings through inner wall 512. Some inert gas flowing within channel 510 flows through louvers 516 into the component along inner wall 512. Additional variations on this approach can be used to deliver a thin film of fluid along the inner wall of the component. Thin film delivery of shielding gases is described further in Published PCT Application WO 01/07155 to Mosso et al., entitled “Particle Production Apparatus,” incorporated herein by reference, and in U.S. Pat. No. 5,827,370 to Gu, entitled “Method And Apparatus For Reducing Build-Up Of Material On Inner Surface Of Tube Downstream From Reaction Furnace,” incorporated herein by reference.

Referring to FIG. 1, collection system 106 can comprise a collector 450, a negative pressure device 452 and a scrubber 454 with appropriate conduits connecting the flow between these components. Collector 450 can be, for example, a filter, an electrostatic collector or the like. Suitable filters include, for example, flat filters or cylindrical filters. In some embodiments of interest, the collector can be a bag collector for continuous collection without disrupting particle production, such as describe in U.S. Pat. No. 5,874,684 to Parker et al., entitled “Nanocrystalline Materials,” and U.S. Pat. No. 6,270,732 to Gardner et al., entitled Particle Collection Apparatus And Associated Methods, both of which are incorporated herein by reference. Suitable negative pressure devices include, for example, pumps, blowers, an aspirator/venturi, compressor, ejector or the like. Vacuum pumps are commercially available, such as available from Leybold Vacuum Products, Export, Pa. or a dry rotary pump from Edwards, such as model QDP80. Optional scrubber 454 can be used to remove environmentally harmful compounds from the filtered flow to reduce their release into the atmosphere. Suitable scrubbers include, for example, in-line Sodasorb® (W. R. Grace) chlorine traps.

The pressure in the reaction chamber generally can be measured with a pressure gauge. For example, a manometer can be used as a pressure gauge. Manometers provide accurate linear responses with respect to pressure. In some embodiments, the pressure gauge is connected to a controller. The controller can be used to monitor the pressure in reaction chamber and maintain the pressure in reaction chamber within a specified range using a feedback loop with the collection system. The operation of the feedback loop depends on the structural design of the collection system, and may involve, for example, the adjustment of a valve, pumping speed and/or filter pulsing rates, with automatic adjustment by the controller. Suitable automatic valves for interfacing with the controller are available from Edwards Vacuum Products, Wilmington, Mass. If manual values are used, the controller can notify an operator to adjust the manual valve appropriately.

As noted above, separate reaction pathways for the formation of inorganic particles can be incorporated into the apparatus. At a selected point in the processing, the different product inorganic particle flows can be combined with or without having modified the inorganic particles within the different synthetic flows. For the in-flight formation of composites with a plurality of inorganic particles, reactive flows originating from two or more independent reactant inlet nozzles generally are used to form the corresponding two or more product inorganic particle streams. To form the two or more independent inorganic particle streams, the independent reactions can be performed in a single reaction chamber and/or in a plurality of reaction chambers with appropriate exit channels to facilitate the modification and combination of the inorganic particle streams to form the desired composite particles. For example, the different inorganic particle product flows can be directed to respective conduits that are combined at a suitable manifold. In other embodiments, the reactive flows can be formed in a single reactive chamber with independent reactant inlets and independent reaction zones and appropriately combined for further processing.

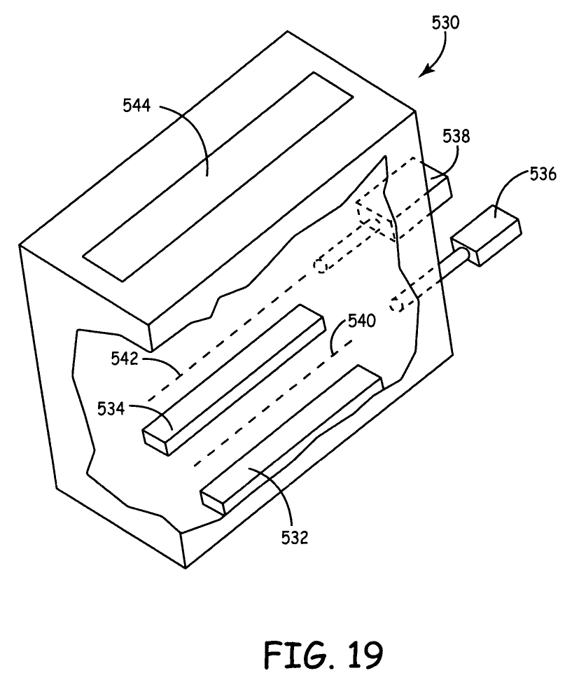

One embodiment of an apparatus to perform the combination of two inorganic reactive flows is shown schematically in FIG. 19. Laser pyrolysis reaction chamber 530 comprises two independent reactant inlets 532, 534, each being connected to a reactant delivery system. Shielding gas from shielding gas inlets around the reactant inlets can be used to entrain the reactant flows. Flow from independent reactant inlets 532, 534 intersects light beams from light sources, e.g., lasers, 536, 538, respectively at independent light reaction zones 540, 542. However, the flows are configured to gradually result in the intersection of the independent reactive flow at some point after the light reaction zones 540, 542. The ultimately merged flows exit a single outlet 544 to enter a conduit system for further processing and/or collection. Furthermore, addition of further reactants to the flow of product inorganic particles can be performed within the reaction chamber. The exit from the reaction chamber may or may not have a clear demarcation and may be identified by some redirection of the flow or other change in the flow environment.

Process For In Situ Coating

The modification processes described herein are performed in-flight. Thus, a flow of precursors for inorganic particles is initiated to begin the process. This flow of inorganic precursors is reacted to form inorganic particles within the flow. The as-formed inorganic particles are modified along their flow prior to their collection. This modification can involve irradiation of the inorganic particles to modify their properties and/or the application of a coating composition. Once the modifications are complete the resulting particles are collected.

The reference to in-flight processing refers to a process in which the intermediates are continuously in motion relative to a fixed frame of reference, which generally is the apparatus and the room or room(s) in which that apparatus is located. The rate of the flow with respect to either mass per unit time or net velocity can change along the flow path due to modification in the flow parameters and/or the addition of materials to the flow, but the particles within the flow do not come to a rest until the final product particles are collected. All of the processing can be performed in a single chamber, or one or more processing steps can be performed in separate flow passageways or other chambers. A particular chamber can be identified using conventional understandings on these issues with respect to narrowing or nozzle structures indications of leaving a chamber or widening or similar demarcations indicating entrance into a chamber.

The generation of inorganic particles within the flow is described in detail above in the context of suitable apparatuses. The reaction conditions can be selected to result in a desired composition and properties of the inorganic particles. Nevertheless, some heat treatment has been found to be useful to improve the crystallinity, change the crystal structure and/or remove some surface impurities, such as elemental carbon. In the past, this post processing has been performed on the collected particles. See, for example, U.S. Pat. No. 6,749,648 to Kumar et al., entitled “Lithium Metal Oxides,” incorporated herein by reference. However, this inorganic particle processing can be performed in-flight using the apparatuses described above. In particular, radiation can be directed to the inorganic particle flow to modify the properties of the inorganic particles. For example, heat can be applied through infrared irradiation, microwave irradiation or other forms of radiation. Alternatively or additionally, heat can be added by heating the wall of the component and/or through the addition of a heated gas. This in situ heating process can be useful to anneal crystalline forms already formed in the synthesis process or to alter the crystal structure. The gas atmosphere surrounding the inorganic particle flow can be selected to result in desired crystal formation during the in situ heating process. The gas environment can be altered through the addition of suitable gas which can be delivered using elements configured for the delivery of inert gas into the flow. For example, H₂ can be introduced to make the environment more reducing, and O₂ can be introduced to make the environment more oxidizing. The degree of heating can be controlled to avoid damaging the particles within the flow. Since crystal formation can require some time, the conditions for inorganic particle processing can be adjusted appropriately, and the reaction chamber and/or flow channel can be correspondingly extended.

Following inorganic particle modification, if any, a coating composition can be applied. The amount of coating composition, the properties of the coating composition and the coating process configuration can influence the amount of coating composition deposited on the inorganic particles as well as the uniformity of the coating on the resulting particles. To form a single coating, a single coating composition can be applied or a plurality of coating compositions can be applied either simultaneously and/or sequentially with respect to position in the flow. If sequentially applied coating compositions are directed to the inorganic particle flow, these can form a single layer if the two or more coating compositions are, for example, miscible and/or reactive with each other. In other words, sequential application of coating compositions can be performed through sequential positioning in the flow so that for particular particles in the flow the sequential application of coating composition is sequential in time for particular particles. Similarly, sequential application of coating compositions can be designed to form different coating layers over the inorganic particle cores depending on the properties of the coating compositions and the time delay between sequential deposition of the coating compositions.

Once a coating composition or a blend of coating compositions is applied, the coating can spontaneously react to transform its initial composition. Such spontaneous reactions can involve, for example, bonding with the inorganic particle surface or an inner coating or linker molecule, solidification due to solvent evaporation, polymerization and/or crosslinking, combinations thereof, or the like. Additionally or alternatively, the coated particles can be subjected to radiation to effectuate the changes in the coating composition. For example, infrared or microwave electromagnetic radiation can be used to heat the particles and visible, ultraviolet electromagnetic radiation or an electron beam can be used to initiate particular reactions. In some embodiments, these modifying processes can pacify the particle coating so that upon collection of the particle adjacent particles do not inappropriately interact, although this pacification may only apply to a top layer if there is a plurality of coating layers. In some embodiments, an inner coating layer may not be pacified such that it interacts appropriately with an upper layer.

Furthermore, it may be desirable to provide in-flight processing of a coating composition prior to combining the coating composition with an inorganic particle flow. The coating composition processing channel can be initiated with a nozzle inlet similar to those shown in FIGS. 3-6 for delivering inorganic particle precursors. The coating composition modification channel can be similar to the flow/modification section described above with respect to FIG. 13. In particular, the coating composition modification channel may or may not comprise modification elements. If there are no modification elements, the initiation of the flow of coating composition may initiate modification processes, such as polymerization and/or crosslinking, without further interaction with the flow. However, modification elements can comprise nozzles to deliver additional compositions or radiation sources to induce modification of the flow of coating composition. Following completion of the coating composition modification, the coating composition is directed to interact with the inorganic particle flow through a coating composition nozzle of the like. In-flight polymerization processes and corresponding apparatuses are described further, for example, in U.S. Pat. No. 4,929,400 to Rembaum et al., entitled “Production of Monodisperse, Polymeric Microspheres,” U.S. Pat. No. 5,269,980 to Levendis et al., entitled Production of Polymer Particles in Powder Form Using an Atomization Techniques,” and U.S. Pat. No. 6,291,605 to Freeman et al., entitled “Polymerization Process With Spraying Step,” all three of which are incorporated herein by reference.

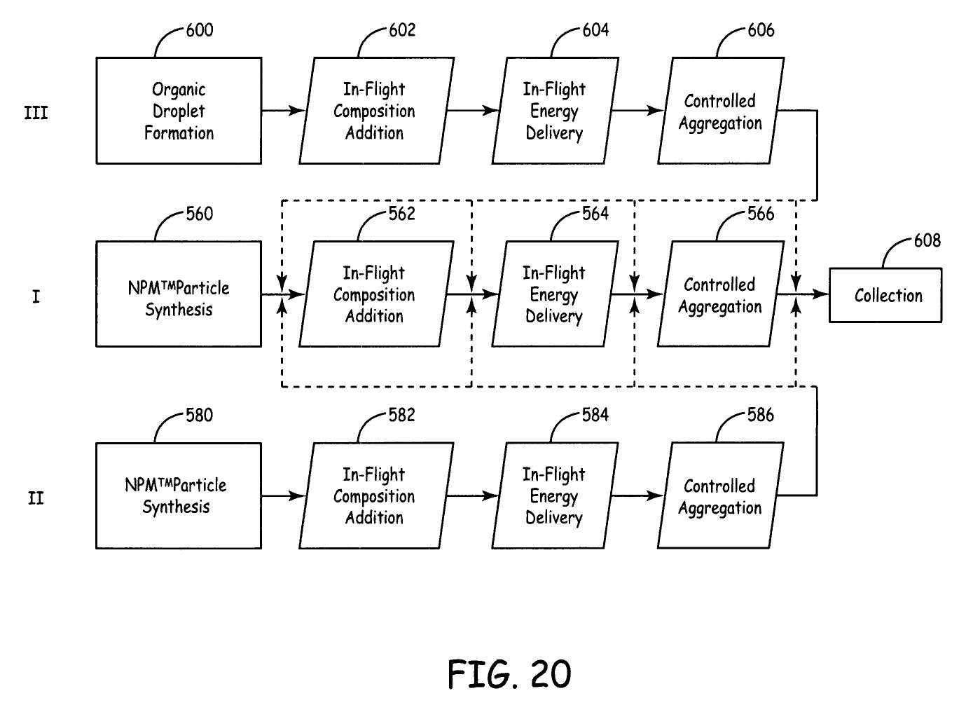

These individual processing steps to modify particles within the flow can result in highly desirable and efficient production of selected materials. These in-flight processing approaches can be combined in a multitude of ways as suggested in the descriptions of the above. The various combinations of processing options are outlined in FIG. 20.

The general diagram of FIG. 20 broadly indicates optional approaches for in-flight processing with a plurality of inorganic particle channels and a coating composition processing channel. The coating composition can be alternatively referred to as a non-mineral composition. Herein, a non-mineral composition refers to, for example, organic compositions as well as silicon-based compositions, and/or surface modification compositions. Non-mineral compositions are in contrast with the inorganic particles which can be ceramic and generally have a mineral like composition. Generally, the non-mineral droplets are deformable such that they can coat or envelope the inorganic particles.

Referring to FIG. 20, Channels I and II are inorganic particle production and processing channels, and Channel III is a coating composition production and processing channel. Channels II and III are optional, and additional inorganic processing channels and/or coating composition processing channels can be added as appropriate. As shown in FIG. 20, the processing steps are shown succinctly with steps shown as addition of compositions, delivery of energy or controlled aggregation.

Channel I comprises inorganic particle synthesis 560 with optional modification. In-flight composition addition 562 can comprise addition of monomers/oligomers and/or the addition of other additives, such as organic pigments, surface modifiers, wax, charge control agents or the like or combinations thereof. In-flight energy delivery 564 can involve energy delivery for curing, and/or the addition of surface charge and/or the like. Similarly, controlled aggregation 566 can involve application of surface charge, altering flow density and/or the like. These processing steps can be omitted or repeated as appropriate, and the order of these processing steps can be selected as desired. Channel II similarly comprises inorganic particle synthesis 580, optional in-flight composition addition 582, optional in-flight energy delivery 584 and optional controlled aggregation 586.

Non-mineral processing channel III generally can be initiated with droplet formation 600. Techniques have been developed to form well collimated and entrained aerosol flows. See, for example, U.S. Pat. No. 6,193,936 to Gardner et al., entitled “Reactant Delivery Apparatuses,” incorporated herein by reference, which can be adapted for flows without inorganic precursors. Initial droplets can comprise polymer/monomers/oligomers, solvent and/or other organic or silicon-based composition(s), such as pigments or property modifiers. Once the initial droplets are formed, one or more additional processing steps can be performed, as desired. For example, one or more additional compositions can be added 602 to the flowing droplets, for example, using vapor deposition and/or aerosol deposition. Similarly, one or more steps involving the addition of energy/radiation 604, such as a corona discharge, infrared light, ultraviolet light, or the like, or combinations thereof. Furthermore, controlled aggregation can be performed 606, such as through modifications in the flow and/or through adjustments in the surface charges of the droplets. These processing steps can be omitted or repeated as appropriate, and the order of these processing steps can be selected as desired.

Flows from channels II, III or others can be combined with the flow from channel I. For example, with respect to combining multiple inorganic particles in the composite particles, it may be desired, for example, to combine an inorganic semiconductor pigment with a magnetic inorganic particle, which can be desirable for toner particle production. Each flow from channels II or III can be combined with the flow in channel I independently at one or more selected stages in the channel I processing. This is indicated schematically with dashed lines in FIG. 20. However, of course, the processing steps themselves in channel I of FIG. 20 can have fewer steps, additional steps, a different order, etc., such that schematic depiction in FIG. 20 for alternative combining orders for the different channels are only a representative sampling of the possibilities. To combine the flows, in some embodiments, the flows can be directed to intersect along a common conduit, although alternative approaches for combining the flows can be used. For these various embodiments, the composite particles are ultimately collected 608, for example, using one of the various collectors described herein.

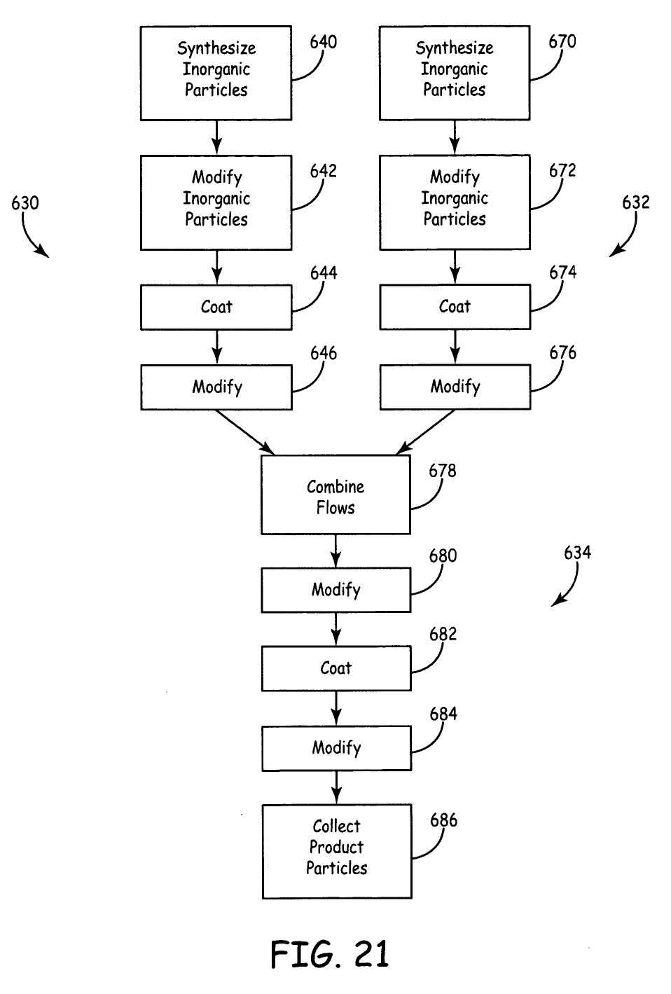

A representative example of the possible processes represented in FIG. 20 is depicted in FIG. 21. In FIG. 21, the process has three branches, processing of a first inorganic particle flow 630, processing of second inorganic particle flow 632 and processing of combined stream 634. As discussed further below, there may only be one inorganic particle processing stream or there may be more than two inorganic particle processing streams. In its simplest form, the overall process only needs to have three processing steps, a synthesis of inorganic particles, a coating or modifying step, and the collection step, although one or more additional steps can be used to accomplish a desired objective.

Referring to FIG. 21, processing of first inorganic particle flow 630 can comprise the synthesis of inorganic particles 640, the modification of inorganic particles 642, a coating step 644 and a modification of the coated particles 646. Modification step 642, coating step 644 and modification step 646 are individually optional such that none, one, two or all three steps may be performed. Similarly, Modification step 642, coating step 644 and modification step 646 individually can be repeated any number of reasonable times and in any desired order to form desired processed inorganic particle flow from process branch 630.

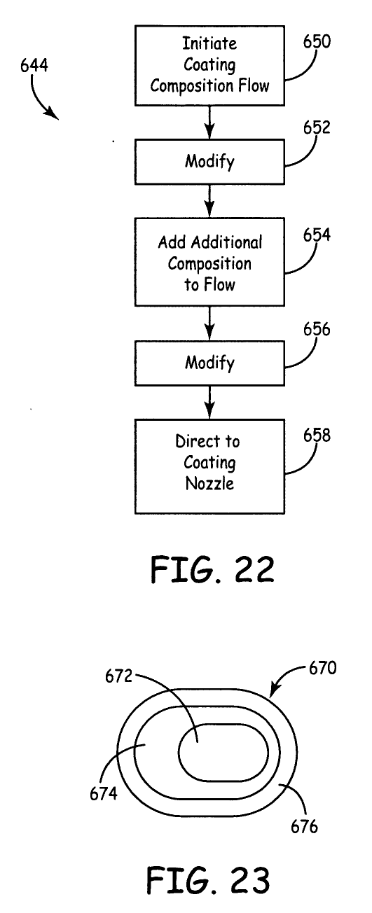

While coating step 644 generally can involve the delivery of a composition from a reservoir, in some embodiments, coating step 644 itself may comprise optionally a plurality of in-flight processing steps to form a coating composition. Referring to FIG. 22, a representative embodiment of in-flight processing to form a coating composition is presented. In this embodiment, coating step 644 comprises initiating a coating composition flow 650, modifying the flow 652, addition of compositions to the coating composition flow 654, modifying the combined flow 656 and directing the coating composition to a coating nozzle 658. Initiating a coating composition flow 650 can comprise directing a gas, vapor and/or aerosol along a flow channel. Modification 652 of the flow can comprise directing radiation or heat to the flow. Addition of a composition to the flow 654 can comprise addition of a composition that reacts with existing components of the flow or a composition that is inert to the compositions already in the flow. Modification of the combined coating composition flow can comprise addition of radiation and/or heat to the flow, which may initiate a reaction, such as crosslinking or polymerization, within the flow. In general, in these embodiments, only one of steps 652, 654 and 656 may be present. On the other hand, the modification steps 652, 656 and addition of composition steps 654 can be repeated independently a reasonable number of times in a desired order to achieve a desired resulting coating composition. The coating nozzle directs the completed coating composition to an inorganic particle flow.

Referring to FIG. 21, processing of second inorganic particle flow 632 may be completely absent. If processing branch 632 is present, processing branch 632 comprises a step of synthesizing the inorganic particles 670 and can further comprise a modification of inorganic particles 672, a coating step 674 and a modification of coated inorganic particles 676. Modification of inorganic particles 672, coating step 674 and modification of coated particles 676 are individually optional. Similarly, the steps of modification of inorganic particles 672, coating step 674 and modification of coated particles 676 can be individually repeated any reasonable number of times in any desired order to form a desired modified second inorganic particle flow.

Referring to FIG. 21, processing of combined streams 634 comprises combining flows 678, modifying the combined flows 680, applying a coating composition 682, modifying the coated particles 684 and collecting the produce particles 686. Combining flows 678 comprises directing particles from the first inorganic particle flow and the second inorganic particle flow to merge in-flight to form a combined flow. The particles from the two inorganic particle flows may be separately processed in-flight as described above with respect to the many options for this processing. Again, modification step 680, coating step 682 and modification step 684 are individually optional such that none, one, two or all three steps may be performed. Similarly, modification step 680, coating step 682 and modification step 684 individually can be repeated any number of reasonable time and in any desired order to form desired processed mixed inorganic particle flow from process branch 634. The collection of the particles 686 terminates the in-flight processing as it terminates the flow.

As shown in FIG. 21, two separate inorganic particle flows are combined, and it is noted above that appropriate processes may have only a single inorganic particle synthesis step and corresponding processing branch. However, in alternative embodiments, three or more inorganic particle flows can be combined. The third or higher inorganic particle flow can be combined also at step 678 or they can be introduced at any selected later step after the first two inorganic particle flows have been combined, and the third inorganic particle flow can be subjected to some form of modification, such as interaction with radiation or a coating composition. Similarly, a fourth inorganic particle flow need not be combined at the same step as the third, and so on for any further inorganic particle flows.

Of course, the particles can be further processed following collection in non-in-flight approaches prior to use. All of the processing approaches whether in-flight or non-in-flight generally are selected based on particle properties appropriate for particular applications.

Particle Compositions

The product particles have an inorganic particle constituent, which may or may not have a coating. For convenience, first the properties of inorganic particles is described, and then the properties of composite particles are described for the appropriate embodiments. These properties of the inorganic particles are applicable whether the inorganic particles are directly the particles collected or if the inorganic particles are embedded within composite particles.

A. Inorganic Particle Properties

In embodiments of particular interest, the inorganic particles have an average diameter of no more than about one micron. A collection of submicron/nanoscale particles may have an average diameter for the primary particles of less than about 500 nm, in further embodiments from about 2 nm to about 100 nm, alternatively from about 2 nm to about 75 nm, or from about 2 nm to about 50 nm. A person of ordinary skill in the art will recognize that other ranges within these specific ranges are contemplated and are within the present disclosure. Particle diameters are evaluated by transmission electron microscopy. For non-spherical particles, diameter measurements on particles are based on an average of length measurements along the principle axes of the particle.

The primary particles can have a roughly spherical gross appearance, or they can have rod shapes, plate shapes or other non-spherical shapes. Upon closer examination, crystalline particles generally have facets corresponding to the underlying crystal lattice. Amorphous particles generally have a spherical aspect. In embodiments with generally spherical particles, the particles can have average aspect ratios of the longest length along a principle axis to the shortest distance along a principle axis of the particle is no more than about 2 and in further embodiments no more than about 1.5. A person of ordinary skill in the art will recognize that additional ranges of aspect ratios within the explicit ranges are contemplated and are within the present disclosure.

The particles generally have a surface area corresponding to particles on a submicron scale as observed in the micrographs. Furthermore, the particles can manifest unique properties due to their small size and large surface area per weight of material. For example, the absorption spectrum of crystalline, nanoscale TiO₂ particles is shifted relative to the spectrum of bulk TiO₂ particles.

The primary particles can have a high degree of uniformity in size. Laser pyrolysis generally results in particles having a very narrow range of particle diameters. With aerosol delivery of reactants for laser pyrolysis, the distribution of particle diameters is particularly sensitive to the reaction conditions. Nevertheless, if the reaction conditions are properly controlled, a very narrow distribution of particle diameters can be obtained with an aerosol delivery system. As determined from examination of transmission electron micrographs, the primary particles generally have a distribution in sizes such that at least about 95 percent, and in other embodiments at least about 99 percent, of the primary particles have a diameter at least about 40 percent of the average diameter and no more than about 160 percent of the average diameter. In further embodiments, the primary particles have a distribution of diameters such that at least about 95 percent, and in other embodiments at least about 99 percent, of the primary particles have a diameter at least about 60 percent of the average diameter and no more than about 140 percent of the average diameter. A person of ordinary skill in the art will recognize that other ranges within these specific ranges are contemplated and are covered by the disclosure herein.

Furthermore, in preferred embodiments no primary particles have an average diameter greater than about 5 times the average diameter, in other embodiments no more than about 4 times the average diameter, in further embodiments no more than about 3 times the average diameter, and in additional embodiments no more than about 2 times the average diameter. In other words, the particle size distribution effectively does not have a tail indicative of a small number of particles with significantly larger sizes. This is a result of the small reaction region and corresponding rapid quench of the particles. An effective cut off in the tail of the size distribution indicates that there are less than about 1 particle in 10⁶ have a diameter greater than a specified cut off value above the average diameter. High particle uniformity can be exploited in a variety of applications. In particular, high particle uniformity can lead to well controlled optical properties. As used herein, primary particles refers to particles that do not display any visible necking on a transmission micrograph, such that the particles are in principle dispersible under appropriate conditions. However, it may not be possible to ideally disperse the particles completely even if there is no visible necking that is hard fusing the particles. Since techniques do not provide for observing the individual particles in a dispersion the details of the dispersion process are necessarily somewhat incompletely understood.

Secondary particle size refers to the size of dispersed particles in a fluid. The secondary particle sizes can be measured with techniques such as light scattering and the like. Commercial instruments can be used to measure the particle sizes in dispersions. In general, the secondary particle size can be the same order of magnitude as the primary particle size. In some embodiments, the average secondary particle size can be less than a factor of five times the average primary particle size and in further embodiments no more than a factor of three larger than the average primary particle size. Furthermore, the techniques described herein, such as cooling the particles prior to collection can further improve the dispersiblity of the particles even more than the generally very good dispersibility of particles formed by laser pyrolysis. Of course, if the particles are coated, the concept of secondary particle size of the inorganic particles is superseded by the corresponding properties of the composite particles.

In addition to the uniformity of the inorganic particles, the inorganic particles may have a very high purity level. Furthermore, crystalline inorganic particles, such as those produced by laser pyrolysis, can have a high degree of crystallinity. Impurities on the surface of the particles may be removed by heating the particles, which can be performed in-flight, to achieve not only high crystalline purity but high purity overall.

A variety of inorganic particle compositions can be produced by laser pyrolysis. Specifically, the compositions can include one or more metal/metalloid elements forming a crystalline or amorphous material with an optional dopant or additive composition. In addition, dopant(s)/additive(s) can be used to alter the optical, chemical and/or physical properties of the particles. In general, the submicron/nanoscale inorganic particles can generally be characterized as comprising a composition comprising a number of different elements and present in varying relative proportions, where the number and the relative proportions can be selected as a function of the application for the particles. Typical numbers of different elements include, for example, numbers in the range(s) from about 2 elements to about 15 elements, with numbers of 1, 2, 3, 4, 5, 6, 7, 8, 9, 10, 11, 12, 13, 14, and 15 being contemplated, in which some or all of the elements can be metal/metalloid element. General numbers of relative proportions include, for example, ratio values in the range(s) from about 1 to about 1,000,000, with numbers of about 1, 10, 100, 1000, 10000, 100000, 1000000, and suitable sums thereof being contemplated. In addition, elemental materials are contemplated in which the element is in its elemental, un-ionized form, such as a metal/metalloid element, i.e., M⁰.

Alternatively or additionally, such submicron/nanoscale particles can be characterized as having the following formula:
AₐB_{b}C_{c}D_{d}EₑF_{f}G_{g}HₕIᵢJⱼKₖLₗMₘNₙOₒ,
where each A, B, C, D, E, F, G, H, I, J, K, L, M, N, and O is independently present or absent and at least one of A, B, C, D, E, F, G, H, I, J, K, L, M, N, and O is present and is independently selected from the group consisting of elements of the periodic table of elements comprising Group 1A elements, Group 2A elements, Group 3B elements (including the lanthanide family of elements and the actinide family of elements), Group 4B elements, Group 5B elements, Group 6B elements, Group 7B elements, Group 8B elements, Group 1B elements, Group 2B elements, Group 3A elements, Group 4A elements, Group 5A elements, Group 6A elements, and Group 7A elements; and each a, b, c, d, e, f, g, h, i, j, k, 1, m, n, and o is independently selected and stoichiometrically feasible from a value in the range(s) from about 1 to about 1,000,000, with numbers of about 1, 10, 100, 1000, 10000, 100000, 1000000, and suitable sums thereof being contemplated. In other words, the elements can be any element from the periodic table other than the noble gases. Elements from the groups Ib, IIb, IIIb, IVb, Vb, VIb, VIIb and VIIIb are referred to as transition metals. In addition to the alkali metals of group I, the alkali earth metals of group II and the transition metals, other metals include, for example, aluminum, gallium, indium, thallium, germanium, tin, lead, bismuth and polonium. The non-metal/metalloid elements include hydrogen, the noble gases, carbon, nitrogen, oxygen, fluorine, sulfur, chlorine, selenium, bromine, and iodine. As described herein, all inorganic compositions are contemplated, as well as all subsets of inorganic compounds as distinct inventive groupings, such as all inorganic compounds or combinations thereof except for any particular composition, group of compositions, genus, subgenus, alone or together and the like.

While some compositions are described with respect to particular stoichiometries/compositions, stoichiometries generally are only approximate quantities. In particular, materials can have contaminants, defects and the like. Similarly, some amorphous materials can comprise essentially blends such that the relative amounts of different components are continuously adjustable over ranges in which the materials are miscible. In other embodiments, phase separated amorphous materials can be formed with differing compositions at different domains due to immiscibility of the materials at the average composition. Furthermore, for amorphous and crystalline materials in which metal/metalloid compounds have a plurality of oxidation states, the materials can comprise a plurality of oxidation states. Thus, when stoichiometries are described herein, the actual materials may comprise other stoichiometries of the same elements also, such as SiO₂ also include some SiO and the like.

With respect to the electrical properties of the particles, some particles include compositions such that the particles are electrical conducting, electrical insulators or electrical semiconductors. Suitable electrical conductors include, for example, elemental metals and some metal compositions. Electrical conductors, such as metals, generally have a room temperature resistivity of no more than about 1×10⁻³ Ohm-cm. Electrical insulators generally have a room temperature resistivity of at least about 1×10⁵ Ohm-cm. Electrical semiconductors include, for example, silicon, CdS and InP. Semiconducting crystals can be classified to include so called, II-VI compounds, III-V compounds and group IV compounds, where the number refers to the group in the periodic table. Semiconductors are characterized by a large increase in conductivity with temperature in pure form and an increase in electrical conductivity by orders of magnitude upon doping with electrically active impurities. Semiconductors generally have a band gap that results in the observed conductivity behavior. At room temperature, the conductivity of a semiconductor is generally between that of a metal and a good electrical insulator.

In some embodiments, powders comprise as a host material, for example, silicon particles, metal particles, and metal/metalloid compositions, such as, metal/metalloid oxides, metal/metalloid carbides, metal/metalloid nitrides, metal/metalloid phosphides, metal/metalloid sulfides, metal/metalloid tellurides, metal/metalloid selenides, metal/metalloid arsinides and mixtures and combinations thereof. Especially in amorphous materials, great varieties of elemental compositions are possible within a particular material. Suitable glass forming host oxides for doping include, for example, TiO₂, SiO₂, GeO₂, Al₂O₃, P₂O₅, B₂O₃, TeO₂, CaO—Al₂O₃, V₂O₅, BiO₂, Sb₂O₅ and combinations and mixtures thereof.

In addition, particles can comprise one or more dopants/additives within an amorphous material and/or a crystalline material. Dopant(s)/additive(s), which can be complex blends of dopant/additive composition(s), generally are included in non-stoichiometric amounts. A dopant/additive is generally metal or metalloid element, although other dopant(s)/additive(s) of interest include fluorine, chlorine, nitrogen and/or carbon, which substitute for oxygen in oxides or other anions relative to metal/metalloid components. The dopant(s)/additive(s) generally can replace other constituents within the material in order to maintain overall electrical neutrality. Dopant(s)/additive(s) can impart desirable properties to the resulting materials. The amount of dopant(s)/additive(s) can be selected to yield desired properties while maintaining appropriate chemical stability to the material. In crystalline materials, dopant/additive element(s) can replace host elements at lattice sites, dopant/additive element(s) can reside at previously unoccupied lattice sites and/or dopant/additive element(s) can be located at interstitial sites. Unlike dopant(s)/additive(s) within crystalline materials in which the crystal structure influences incorporation of the dopant(s)/additive(s), dopant(s)/additive(s) within amorphous materials can behave more as a composition dissolved within the host material to form a solid mixture. Thus; the overall composition of the material influences the chemical properties, including the processing parameters and stability, of the resulting combined materials.

An inorganic composition generally comprises a dopant in the range no more than about 15 mole percent of the metal/metalloid in the composition, in further embodiments in the range no more than about 10 mole percent, in some embodiments in the range from about 0.001 mole percent to about 5 mole percent, and in other embodiments in the range from about 0.025 to about 1 mole percent of the metal/metalloid in the composition. A person of ordinary skill in the art will recognize that additional ranges within the explicit ranges of dopant concentrations are contemplated and the present disclosure similarly covers ranges within these specific ranges. Additive compositions are similar to dopant compositions except that they generally are included at higher amounts while still being a minority component of the composition, i.e., in the range(s) less than about 50 mole percent of the composition. Additive(s) can be useful for many of the same purposes as dopant(s). Doped and doping, for convenience, can refer to materials with dopants and/or additives and the process of incorporating dopants and/or additives, respectively.

Powders, e.g., collections of inorganic particles, can be formed with complex compositions including, for example, one or more metal/metalloid elements in a host material and, optionally, one or more selected dopants/additives. With laser pyrolysis, materials can be formed with desired compositions by appropriately introducing a reactant composition to form the desired host material. Specifically, selected elements can be introduced at desired amounts by varying the composition of the reactant stream. The conditions in the reactor can also be selected to produce the desired materials.

With respect to amorphous particles, i.e., glasses, silica (SiO₂)-based glasses have various existing commercial applications. Other glass forming materials that are suitable for combining with silica to form amorphous host materials include, for example, Al₂O₃, Na₂O, B₂O₃, P₂O₃, GeO₂, and the like and combinations thereof. Thus, a plurality of glass forming compositions can be combined to form a blended glass host composition with desired properties, such as index-of-refraction and glass transition temperature. The blended glass host materials can be doped with further materials to further adjust the properties of the material.

In some embodiments, suitable dopant(s)/additive(s) include, for example, metal/metalloid elements, such as rare earth metals. Rare earth dopants can impart desirable modifications of properties, such as index-of-refraction, photosensitivity, fluorescence and paramagnetism. For example, the rare earth dopant(s)/additive(s) can influence the optical emission properties that can alter the application of the materials for the production of optical amplifiers and other optical devices. Rare earth metals comprise the transition metals of the group IIIb of the periodic table. Specifically, the rare earth elements comprise Sc, Y and the Lanthanide series. Other suitable dopant(s)/additive(s) include elements of the actinide series. For optical glasses, the rare earth metals of interest as dopants/additives comprise Er, Yb, Nd, La, Ce, Tb, Dy, Ho, Sm, Eu, Gd, Pr, Tm, Sc, Y, and the like and combinations thereof. Suitable non-rare earth metal dopants/additives include, for example, Al, Ga, Mg, Sr, Zn, Bi, Sb, Zr, Pb, Li, Na, K, Ba, W, Si, Ge, P, B, Te, Ca, Rb, Sn, In, Ti, Au, Ag, Ta, Mo, Nb, and the like and combinations thereof. Also, certain first-row transition metals have optical emission properties in the visible or infrared regions of the spectrum. Suitable first-row transition elements having desirable optical properties as dopants/additives include, for example, V, Cr, Mn, Fe, Co, Ni and Cu. The wavelength of the optical emission depends on the oxidation-state of the transition-metal.

With respect to laser pyrolysis, the production of silicon oxide submicron/nanoscale particles is described in U.S. Pat. No. 6,726,990 to Kumar et al., entitled “Silicon Oxide Particles,” incorporated herein by reference. This patent application describes the production of amorphous SiO₂. The production of titanium oxide submicron/nanoscale particles is described in U.S. Pat. No. 6,387,531 to Bi et al., entitled “Metal (Silicon) Oxide/Carbon Composites,” incorporated herein by reference. In particular, this application describes the production of anatase and rutile TiO₂.

In addition, submicron/nanoscale manganese oxide particles have been formed. The production of these particles is described in U.S. Pat. No. 6,506,493 to Kumar et al., entitled “Metal Oxide Particles,” incorporated herein by reference. This application describes the production of MnO, Mn₂O₃, Mn₃O₄ and Mn₅O₈.

Also, the production of vanadium oxide submicron/nanoscale particles is described in U.S. Pat. No. 6,106,798 to Bi et al., entitled “Vanadium Oxide Nanoparticles,” incorporated herein by reference. Similarly, silver vanadium oxide submicron/nanoscale particles have been produced, as described in U.S. Pat. No. 6,225,007 to Home et al., and U.S. Pat. No. 6,394,494 to Reitz et al., both entitled “Metal Vanadium Oxide Particles,” both of which are incorporated herein by reference.

Furthermore, lithium manganese oxide submicron/nanoscale particles have been produced by laser pyrolysis along with or without subsequent heat processing, as described in U.S. Pat. No. 6,607,706 to Kumar et al., entitled “Composite Metal Oxide Particles,” and 6,482,374 to Kumar et al., entitled “Reaction Methods for Producing Ternary Particles,” and U.S. Pat. No. 6,136,287 to Home et al., entitled “Lithium Manganese Oxides and Batteries,” all three of which are incorporated herein by reference. The production of lithium cobalt oxide, lithium nickel oxide, lithium cobalt nickel oxide, lithium titanium oxide and other lithium metal oxides is described in U.S. Pat. No. 6,749,648 to Kumar et al., entitled “Lithium Metal Oxides,” incorporated herein by reference.

The production of aluminum oxide submicron/nanoscale particles is described in copending and commonly assigned, U.S. patent application Ser. No. 09/136,483 to Kumar et al., entitled “Aluminum Oxide Particles,” incorporated herein by reference. In particular, this application discloses the production of γ-Al₂O₃. The formation of delta-Al₂O₃ and theta-Al₂O₃ by laser pyrolysis/light reactive deposition along with doped-crystalline and amorphous alumina is described in copending and commonly assigned U.S. patent application Ser. No. 09/969,025 to Chiruvolu et al., entitled “Aluminum Oxide Powders,” incorporated herein by reference.

In addition, tin oxide submicron/nanoscale particles have been produced by laser pyrolysis, as described in U.S. Pat. No. 6,200,674 to Kumar et al., entitled “Tin Oxide Particles,” incorporated herein by reference. The production of zinc oxide submicron/nanoscale particles is described in copending and commonly assigned U.S. patent application Ser. No. 09/266,202 to Reitz, entitled “Zinc Oxide Particles,” incorporated herein by reference. In particular, the production of ZnO submicron/nanoscale particles is described.

Submicron/nanoscale particles of rare earth metal oxide, rare earth doped metal/metalloid oxide, rare earth metal/metalloid sulfides and rare earth doped metal/metalloid sulfides are described in U.S. Pat. No. 6,692,660 to Kumar et al, entitled “High Luminescence Phosphor Particles,” incorporated herein by reference. Suitable host materials for the formation of phosphors comprise ZnO, ZnS, Zn₂SiO₄, SrS, YBO₃, Y₂O₃, Al₂O₃, Y₃Al₅O₁₂ and BaMgAl₁₄O₂₃, and combinations of any two or more thereof. Exemplary non-rare earth metals for activating phosphor particles as dopant(s)/additive(s) include, for example, manganese, silver, lead, and the like and combinations thereof. Exemplary rare earth metals for forming metal oxide phosphors include, for example, europium, cerium, terbium, erbium and the like and combinations thereof. Generally, heavy metal ions or rare earth ions are used as activators in phosphors. For phosphor applications, the particles are generally crystalline.

The production of iron, iron oxide and iron carbide is described in a publication by Bi et al., entitled “Nanocrystalline α-Fe, Fe₃C, and Fe₇C₃ produced by CO₂ laser pyrolysis,” J. Mater. Res. Vol. 8, No. 7 1666-1674 (July 1993), incorporated herein by reference. The production of submicron/nanoscale particles of silver metal is described in U.S. Pat. No. 6,394,494 to Reitz et al., entitled “Metal Vanadium Oxide Particles,” incorporated herein by reference. Submicron/nanoscale carbon particles produced by laser pyrolysis is described in a reference by Bi et al., entitled “Nanoscale carbon blacks produced by CO₂ laser pyrolysis,” J. Mater. Res. Vol. 10, No. 11, 2875-2884 (November 1995), incorporated herein by reference.

The production of iron sulfide (Fe₁₋ₓS) submicron/nanoscale particles by low rate laser pyrolysis is described in Bi et al., Material Research Society Symposium Proceedings, vol. 286, p. 161-166 (1993), incorporated herein by reference. Precursors for laser pyrolysis production of iron sulfide were iron pentacarbonyl (Fe(CO)₅) and hydrogen sulfide (H₂S). Other suitable gaseous sulfur precursors for vapor delivery comprise, for example, pyrosulfuryl chloride (S₂O₅Cl₂), sulfur chloride (S₂Cl₂), sulfuryl chloride (SO₂Cl₂), thionyl chloride (SOCl₂), and the like, and combinations of any two or more thereof. Suitable sulfur precursors for aerosol delivery comprise, for example, ammonium sulfate ((NH₄)₂S), sulfuric acid (H₂SO₄), and the like, and any combinations thereof, which are soluble in water. Other metal/metalloid sulfide materials can be similarly produced.

Metal borates can be similarly formed using one or more metal precursors and a boron precursor. As a specific example, TiB₂ has potential utility in battery applications. Suitable titanium precursors include, for example, titanium tetrachloride (TiCl₄), titanium isopropoxide (Ti[OCH(CH₃)₂]₄), and the like, and combinations of any two or more thereof. Suitable boron precursors comprise, for example, boron trichloride (BCl₃), diborane (B₂H₆), BH₃, and the like, and combinations of any two or more thereof.

Cerium oxide can be produced using the laser pyrolysis apparatuses described above. Suitable precursors for aerosol delivery comprise, for example, cerous nitrate (Ce(NO₃)₃), cerous chloride (CeCl₃), cerous oxalate (Ce₂(C₂O₄)₃), and the like, and combinations of any two or more thereof. Similarly, zirconium oxide can be produced using the laser pyrolysis apparatuses described above. Suitable zirconium precursors for aerosol delivery comprise, for example, zirconyl chloride (ZrOCl₂), zirconyl nitrate (ZrO(NO₃)₂), and the like, and combinations of any two or more thereof.

Dielectric materials for chip capacitors are described in U.S. Pat. No. 6,917,511 to Bryan, entitled “Reactive Deposition For The Formation Of Chip Capacitors,” incorporated herein by reference. Suitable dielectric materials include a majority of barium titanate (BaTiO₃), optionally mixed with other metal oxides. Other dielectric oxides suitable for incorporation into ceramic chip capacitors with appropriate dopant(s)/additive(s) comprise, for example, SrTiO₃, CaTiO₃, SrZrO₃, CaZrO₃, Nd₂O₃-2TiO₃, La₂O₃-2TiO₂, and the like, and any two or more thereof.

The production of ternary submicron/nanoscale particles of aluminum silicate and aluminum titanate can be performed by laser pyrolysis following procedures similar to the production of silver vanadium oxide submicro/nanoscale particles described in U.S. Pat. No. 6,394,494 to Reitz et al., entitled “Metal Vanadium Oxide Particles,” incorporated herein by reference. Suitable precursors for the production of aluminum silicate comprise, for vapor delivery, a mixture of aluminum chloride (AlCl₃), silicon tetrachloride (SiCl₄), and the like, and combinations thereof, and, for aerosol delivery, a mixture of tetra(N-butoxy) silane and aluminum isopropoxide (Al(OCH(CH₃)₂)₃), a mixture of tetraethoxysilane and aluminum nitrate, or tetraethoxysilane and aluminum chloride, or tetraethoxysilane and aluminum isopropoxide, and the like, and combinations of any two or more thereof. Similarly, suitable precursors for the production of aluminum titanate comprise, for aerosol delivery, a mixture of aluminum nitrate (Al(NO₃)₃) and titanium dioxide (TiO₂) powder dissolved in sulfuric acid, a mixture of aluminum isopropoxide and titanium isopropoxide (Ti(OCH(CH₃)₂)₄), and the like, and combinations of any two or more thereof.

The formation of submicron/nanoscale particles of metal/metalloid compositions with complex anions is described in copending U.S. patent application Ser. No. 09/845,985 to Chaloner-Gill et al., entitled “Phosphate Powder Compositions And Methods For Forming Particles With Complex Anions,” incorporated herein by reference. Suitable polyatomic anions include, for example, phosphate (PO₄⁻³), sulfate (SO₄⁻²), silicate (SiO₄⁻⁴), and the like, and combinations of any two or more thereof. Suitable cations comprise, for example, metal and metalloid cations. Phosphate glasses can be used in a variety of contexts.

The synthesis by laser pyrolysis of silicon carbide and silicon nitride is described in copending and commonly assigned U.S. patent application Ser. No. 09/433,202 to Reitz et al., entitled “Particle Dispersions,” incorporated herein by reference. Other metal/metalloid carbides and metal/metalloid nitrides can be similarly produced.

Rare earth metal and other dopants for amorphous particles as well as complex amorphous particle compositions, and in particular, erbium doped aluminum silicate and aluminum-lanthanum-silicate particles, are described in U.S. Pat. No. 6,849,334 to Horne et al., entitled “Optical Materials And Optical Devices,” incorporated herein by reference.

B. Composite Particles

In some embodiments, the composite particles have a coating over an inorganic particle core. The coating can comprise one or more layers, although a “layer” need not be distributed over the entire surface of the particle. A layer structure may be surmised from the production process, the characteristics of the compositions and a spectroscopic analysis of the coating since direct observation of the layers may not be feasible. A particular coating layer may be characterized by an average thickness even if the coating does not cover the entire particle surface. In some embodiments, some controlled agglomeration can be used to form composite particles with a plurality of embedded inorganic particles within the composite particles.

A representative composite particle structure with a layered structure is depicted schematically in FIG. 23 to serve as a reference point for further discussion, although specific features depicted are not of particular relevance. As shown in FIG. 23, particle 670 has an inorganic particle core 672, a first coating layer 674 and a second, optional coating layer 676. The inorganic particle may or may not be chemically bonded to first coating layer 674, and second coating layer 676 may or may not be chemically bonded to first coating layer.

With respect to the reference structure shown in FIG. 16, there can be variation with respect to the average particle structure as well as a distribution of particle structures within a collection of composite particles. With respect to distribution of particle structures, all of the particles may not be coated within a collection of composite particles. In some embodiments, essentially all of the particles are coated. This can be expresses as no more than about 1 particle in 1000 does not have any coating along its surface. In other embodiments at least about 90 percent of the particles are coated, i.e., no more than 10 percent are uncoated. A coating may or may not cover the entire inorganic particle surface. If the coating only covers a portion of the surface, the coating may be separated into islands or it can be pooled together.

A second coating layer similarly may or may not cover the first coating layer for a portion of the particles. More specifically, if two coating compositions are applied to the flow, some of the particles may be uncoated, a portion of the particles may be coated only with the first coating composition, another portion may be coated only with the second coating composition while most of the particles are coated with sequential layers of the first coating and the second coating. The coating process can be adjusted to provide for more uniform coating. In addition, the composite particles can comprise a third, fourth, or more layers, as described above with respect to processing. The overall shape of the composite particle may or may not be roughly spherical, and may or may not reflect the shape of the inorganic particle core if the relative amount of coating is sufficiently high to influence the overall shape of the composite.

The average structure can be varied in a variety of ways. With respect to an average over all of the composite particles of a collection, the weight ratio of the inorganic particles to the coating(s) can be from about 1000 to about 1×10⁻⁶, in other embodiments from about 250 to about 0.0001, in further embodiments from about 200 to about 0.01 and in additional embodiments from about 100 to about 0.1. If there are a plurality of coatings, the relative amount of coating material within each layer can be selected as desired. In some embodiments, the weight ratio of coating material in two different coating layers relative to the coating with the smaller amount of material may be no more than about 500:1, in other embodiments no more than about 100:1, and in further embodiments no more than about 20:1. A person of ordinary skill in the art will recognize that additional ranges of ratios of inorganic particles to coating material or between two different coating materials within the explicit ranges above are contemplated and are within the present disclosure.

In some embodiments, the composite particles have an average diameter of no more than about 5 microns, in further embodiments no more than about a micron, in other embodiments from about 5 nm to about 250 nm and in additional embodiments from about 5 nm to about 50 nm. A person of ordinary skill in the art will recognize that additional ranges of average diameters within the explicit ranges above are contemplated and are within the present disclosure. As with the inorganic core particles, the diameter of a particle is evaluated as an average of the lengths along the principle axes of the particle. These diameters are evaluated by transmission electron microscopy (TEM). In some embodiments, the average aspect ratio of the particles is no more than about 2.

In general, the coating compositions can comprise any reasonable composition that can be delivered to the inorganic particle flow. These coating compositions can comprise, for example, organic compounds, silicon-based compounds, organometallic compounds, silicon-metallic compounds, combinations thereof and mixtures thereof. Following further modification, the silicon compounds may not be clearly distinguishable from inorganic compositions of the particles. However, in some embodiments, the silicon coating materials have at least about 25 atomic percent H relative to the number of silicon atoms in the composition, in further embodiments, at least about 50 atomic percent hydrogen and in other embodiments at least about 100 atomic percent hydrogen. A person of ordinary skill in the art will recognize that additional ranges of H (hydrogen) content in the silicon coating materials within the explicit ranges above are contemplated and are within the present disclosure. The coating materials can be surface modifiers, polymers, functional compositions, and/or the like, and the coating compositions are related compositions that ultimately result in the coating material by the time that the composite particles are collected.

Surface modifiers can comprise molecules that have properties that encourage the compositions to spread over the particle surfaces and interact with the surface. These molecules can facilitate further processing through the formation of stable coated particles with predictable processing attributes provides by the surface modifier. The surface modifier may or may not bond with the particle surface. Classes of surface modifiers include, for example, compositions with selected functional groups that bond to the inorganic particle surface and surface active agents, which may or may not chemically bond to the inorganic particle surfaces. Suitable surface active agent include, for example, anionic surfactants, cationic surfactants, zwitter-ionic surfactants and non-ionic surfactants.

Suitable surface modifiers that bond to the particle surface depend on the chemical composition of the particles as well as possibly their surface chemistry. In general, suitable compounds for bonding to metal/metalloid oxide particles include, for example, carboxylic acids and alkoxyorganosilanes. The carboxylic acid molecules undergo an esterification-type reaction with the particle surface while the alkoxyorganosilanes react to form a bridging oxygen atom with the particle surface with the displacement of alkoxy group. Generally, thiol groups can be used to bind to metal sulfide particles and certain metal particles, such as gold, silver, cadmium and zinc. Carboxyl groups can bind to other metal particles, such as aluminum, titanium, zirconium, lanthanum and actinium. Similarly, amines and hydroxide groups would be expected to bind with metal oxide particles and metal nitride particles, as well as to transition metal atoms, such as iron, cobalt, palladium and platinum. A surface modifier composition can be applied with a solvent that facilitates the reaction with the inorganic particles while the solvent subsequently evaporates prior to collection of the inorganic particles.

If the surface modifiers have a functional group that does not bind to the inorganic particle, the surface modifier can be used to bond to another coating composition applied with and/or over the surface modifier. For example, the surface modifier can bond to a polymer or monomer units applied to the surface to form a polymer network or crosslinked polymer. Processes to form bonded inorganic particle-polymer composites as bulk composites are described further in U.S. Pat. No. 6,599,631 to Kambe et al., entitled “Polymer-Inorganic Particle Composites,” incorporated herein by reference.

Generally, any polymer that can be delivered into the flow can be applied as a coating composition. Thus, certain highly viscous polymer solutions or polymer melts that would solidify too rapidly in the flow may not be suitable for use as coating compositions. However, the molecular weights of the polymers may be selected to yield suitable coating compositions. In some embodiments, monomers or oligomers can be delivered in the coating composition, which are subsequently polymerized or crosslinked following their delivery onto the inorganic particles. A coating composition can comprise a catalyst to initiate the polymerization and/or crosslinking. Alternatively or additionally, heat and/or radiation can be used to initiate the polymerization and/or crosslinking.

Suitable organic polymers include, for example, polyamides (nylons), polyimides, polycarbonates, polyurethanes, polyacrylonitrile, polyacrylic acid, polyacrylates, polyacrylamides, polyvinyl alcohol, polyvinyl chloride, heterocyclic polymers, polyesters, modified polyolefins and copolymers and mixtures thereof. Composites formed with nylon polymers, i.e., polyamides, and inorganic nanoparticles can be called Nanonylon™. Suitable polymers include, for example, conjugated polymers within the polymer backbone, such as polyacetylene, and aromatic polymers within the polymer backbone, such as poly(p-phenylene), poly(phenylene vinylene), polyaniline, polythiophene, poly(phenylene sulfide), polypyrrole and copolymers and derivatives thereof. Some polymers can be bonded to a surface modifier at functional side groups. The polymer can inherently include desired functional groups, can be chemically modified to introduce desired functional groups or copolymerized with monomer units to introduce portions of desired functional groups.

Silicon-based polymers include polysilanes, polysiloxane (silicone) polymers, such as poly(dimethylsiloxane) (PDMS) and copolymers and mixtures thereof as well as copolymers and mixtures with organic polymers. To form bonded composites, the polysiloxanes can be modified with amino and/or carboxylic acid groups. Polysiloxanes are desirable polymers because of their transparency to visible and ultraviolet light, high thermal stability, resistance to oxidative degradation and its hydrophobicity. Other inorganic polymers include, for example, phosphazene polymers (phosphonitrile polymers).

Appropriate functional groups for binding with the polymer depend on the functionality of the polymer. Generally, the functional groups of the polymers and a surface modifier can be selected appropriately based on known bonding properties to form a chemically bonded composite structure. For example, carboxylic acid groups bond covalently to thiols, amines (primary amines and secondary amines) and alcohol groups. As a particular example, nylons can include unreacted carboxylic acid groups, amine groups or derivatives thereof that are suitable form covalently bonding to a surface modifier. In addition, for bonding to acrylic polymers, a portion of the polymer can be formed from acrylic acid or derivatives thereof such that the carboxylic acid of the acrylic acid can bond with amines (primary amines and secondary amines), alcohols or thiols of a surface modifier. The functional groups of the linker can provide selective linkage either to only particles with particular compositions and/or polymers with particular functional groups. Other suitable functional groups for the surface modifier include, for example, halogens, silyl groups (—SiR₃₋ₓ,Hₓ), isocyanate, cyanate, thiocyanate, epoxy, vinyl silyls, silyl hydrides, silyl halogens, mono-, di- and trihaloorganosilane, phosphonates, organometalic carboxylates, vinyl groups, allyl groups and generally any unsaturated carbon groups (—R′-C═C—R″), where R′ and R″ are any groups that bond within this structure. Selective linkage can be useful in forming composite structures that exhibit self-organization.

Suitable active compounds for coating compositions provide desired functionality to the composite particles. In some embodiments, suitable organic compounds with specific properties include, for example, pigments, dyes, waxes, catalysts, charge retention agents, charge control agents and antioxidants. Suitable dyes and pigments are generally known in the art.

Desired pigments/dyes for color application are generally primary colors cyan, magenta, yellow or combinations thereof. For example, suitable dyes and pigments include, for example, monoazo dyes, diazo dyes, triphenodioxazines, 2,9-dimethyl substituted quinacridone dyes, anthraquinone dyes, copper tetra(octadecyl sulfonamido) phthalocyanine, x-copper phthalocyanine pigment (color index CI 74160), diarylide yellow 3,3-dichlorobenzidene acetoacetanilides (CI 12700), 2,5-dimethoxy-4-sulfonamide phenylazo-4′-chloro-2,5-dimethoxy acetoacentanilide as well as pigments from Paul Uhlich & Co., Inc. (HELIOGEN BLUE™ L6900, D7080, D7020, PYLAM OIL BLUE™, PYLAM OIL YELLLOW™, PIGMENT BLUE 1™), Dominion Color Corp., Ltd., Toronto, Ontario Canada (Pigment Violet 1, Pigment Red 48, Lemon Chrome Yellow DDC 1026™, E. D. TOLUIDINE RED™, BON RED C™), Hoechst (NOVAPERM YELLOW FGL™, HOSTAPERM PINK E™) and DuPont (CINQUASIA MAGENTA™).

Suitable additional charge additives include, for example, charge additives known in the art, such as alkyl pyridinium halides, bisulfates, distearyl dimethyl ammonium methyl sulfate, behenyl trimethyl ammonium methyl sulfate, alkyldimethylbenzyl ammonium salts, 4-azo-1-azoniabicyclo (2.2.2) octane salts and alkoxylated amines. Charge additives are described further in U.S. Pat. No. 4,560,635 to Hoffend et al., entitled “Toner Compositions With Ammonium Sulfate Charge Enhancing Additives,” incorporated herein by reference.

Suitable waxes include waxes known in the art such as waxes and wax emulsions available from Allied Chemical (polypropylenes, polyethylenes, chlorinated polypropylenes and polyethylenes and mixtures thereof), Petrolite Corp. (polypropylenes, polyethylenes, chlorinated polypropylenes and polyethylenes and mixtures thereof), Michaelman Inc., Daniels Product Co., Eastman Chemical Products, Inc. (EPOLENE N-15™). Sanyo Kasei K. K (VISCOL 55-P™ a low average molecular weight polypropylene), Micro Powder Inc. (AQUA SUPERSLIP™ 6550 and 6530, functionalized waxes and fluorinated waxes POLYFLUO™ 190, 200, 523×F, AQUA POLYFLUO™ 411, AQUA POLYSILK™ 19, POLYSILK™ 14, mixed fluorinated and functionalized waxes MICROSPERSION 19™), and S.C. Johnson Wax (functionalized acrylic polymer emulsions JONCRYL™ 74, 89, 130, 537, and 538). Other suitable waxes include, for example, solid paraffin wax, rice wax, amide wax, fatty acid wax, fatty acid metallic salt wax, fatty ester wax, partially-saponified fatty ester wax, silicon wax and carnauba wax. Waxes can be delivered with a suitable solvents.

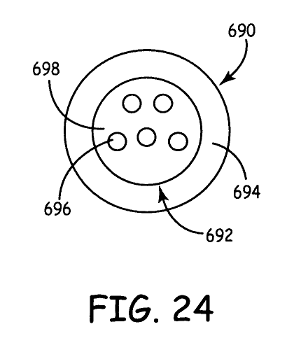

In some embodiments, some controlled agglomeration of the particles can be accomplished in the flow through the adjustment of the particle density and the coating conditions. Thus, it is possible to form particles with the structure such as shown schematically in FIG. 24. Referring to FIG. 24, composite particle 690 comprises a composite core 692 and an optional coating 694. Composite core 692 comprises inorganic particles 696 embedded in a binder composition 698. Binder composition 698 can be applied using the coating deposition approaches described above under conditions in which a desired degree of agglomeration takes place. Coating 694 can generally be applied following the formation of composite core 692.

The weight ratio of binder composition to inorganic particles can fall within the ranges provided above for inorganic particles to coating, and the binder composition within the composite structures of FIG. 24 can broadly still be considered a coating. Similarly, the weight ratio of composite core 692 to coating 694 can fall within the same ranges above for inorganic particles to coating. The average particle sizes for composite cores 692 and composite particles 690 can fall within the ranges above for composite particles generally. While FIG. 24 depicts composite particle 690 with a single over layer 694, composite particles 690 can have a plurality of coatings over composite core 692.

Applications

The composite particles can be used for a wide range of applications. For example, inorganic particles with a surface modifier can be collected to improve dispersion of the particles. Composite particles with a polymer can be used for applying coatings for the formation of devices in a wide range of applications. The polymer of the composite can be selected based on subsequent processing considerations, such as flow temperature, and/or for functional considerations, such as index of refraction or transparency. Additionally or alternatively, functional compositions can be associated with the inorganic particles in anticipation of later uses. For example, pigments can be associated with the inorganic particles for forming colorants for the formation of coating, printing materials or colored articles.

The composite particles at some point in their use generally are incorporated into a further structure. In some embodiments, improved dispersibility of the composite particles provides for taking advantage of the small average size of the particles such that the composite particles can be incorporated into smaller structures and/or structures with sharper boundaries. As noted above, the composite particles can be used as formed or further processed into a modified powder or a dispersion for subsequent use. A wide range of coatings can be formed from the composite particles. Two applications of interest include, for example, printing and optical coatings.

For toner and ink applications, the inorganic particles and the coating can separately provide desirable features for the application. For example, the inorganic particle can provide for the visual appearance, reflectivity, color, absorption electrical properties or the like. The coatings can provide pigmentation, binders, charge control capability or other desirable properties. Composite particles for use in inks can be similar to toner particle, although the coating generally is selected to provide for desired dispersability within a desired liquid and for the anchoring to appropriate substrates upon evaporation of the dispersant. With appropriately selected optical properties, inks formed with composite particles with suitable optical properties can be used to form printable optical elements.

While the particles can be used in selected applications following collection from the in-flight processing, the as collected particles can be processed to form further structured composite particles. In particular, the collected modified inorganic particles can be incorporated into further processing into composite particles, if desired, whether or not the ultimate composite structure could have been formed through an in-flight process. The formation of inorganic particle composite particles with simple to complex structures, as well as further details on toner particle structures and further applications of composite particles, are described further in copending and filed on the same date as the present application U.S. patent application Ser. No. 11/______ to Chiruvolu et al., entitled “NanoStructrured Composite Particles and Corresponding Processes,” incorporated herein by reference.

### EXAMPLE

### In Situ Silanization of Rutile Titanium Oxide

This example demonstrates the ability to surface modify rutile titanium oxide particles formed by laser pyrolysis, in-flight prior to collection of the particles.

The laser pyrolysis was performed in an apparatus essentially as shown in FIG. 12. As shown in FIG. 12, an epoxy trimethoxy silane is introduced into the coating nozzle 400 through a conduit. In some alternative embodiments, the apparatus has been modified for the delivery of epoxy trimethoxy silane composition into the chamber along a baffle leading to the exit nozzle.

Reaction conditions were set to produce rutile titanium dioxide with BET surface areas of roughly either 100 m²/g or 150 m²/g. The reaction conditions to form rutile titanium dioxide is discussed further in U.S. Pat. No. 6,599,631 to Kambe et al., entitled “Polymer-Inorganic Particle Composites,” incorporated herein by reference.

The epoxy trimethoxy silane ((CH₃O)₃SiCH₂CH₂CH₂OCH₂CHOCH₂) was delivered by bubbling dry nitrogen gas through a heated liquid of the silane. The particle stream was cooled and maintained at a temperature below the silane decomposition temperature of 150° C. by diluting the flow with nitrogen gas. The particle modification was performed in different runs at several silane flows.

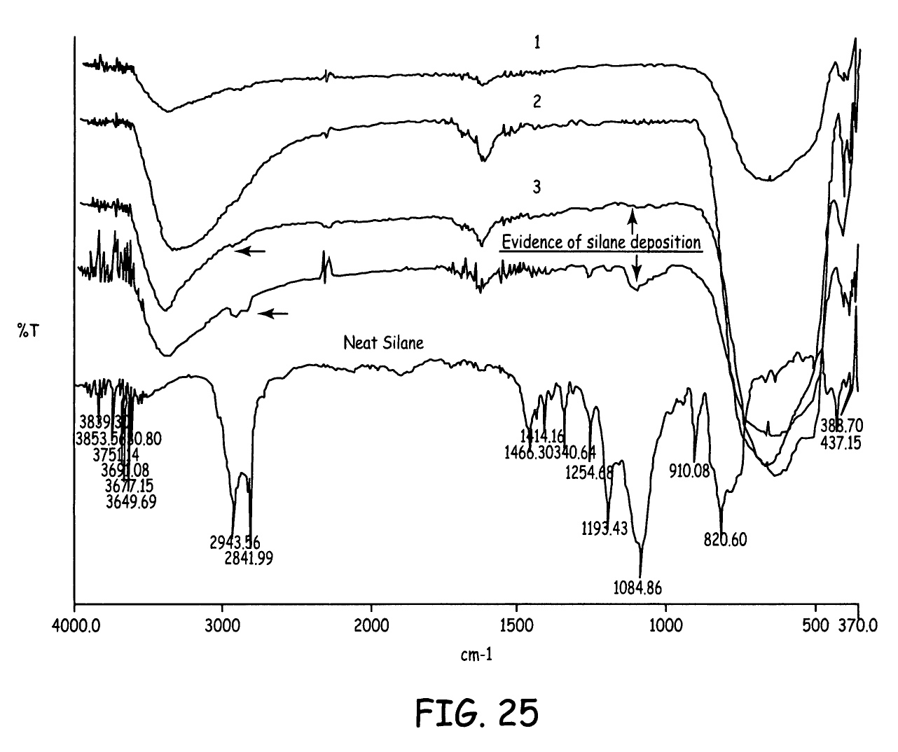

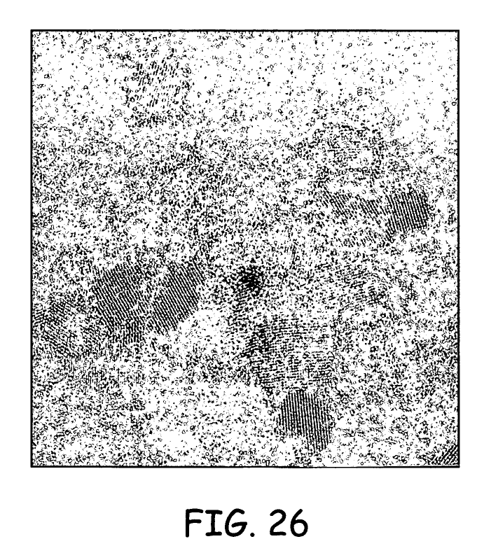

Results are presented in the FIG. 25 for the infrared spectra of four samples of silane modified titanium dioxide particles. For comparison, a spectrum for the silane itself is presented. As the silane flow is increased from samples 1 to 4, clear evidence of the presence of silane on the particles is evident. At least samples 3 and 4 exhibit peaks evidencing silane. A transmission electron micrograph of the particles is shown in FIG. 26. A halo around the particles seems to correspond to the epoxy silane coating around the particles.

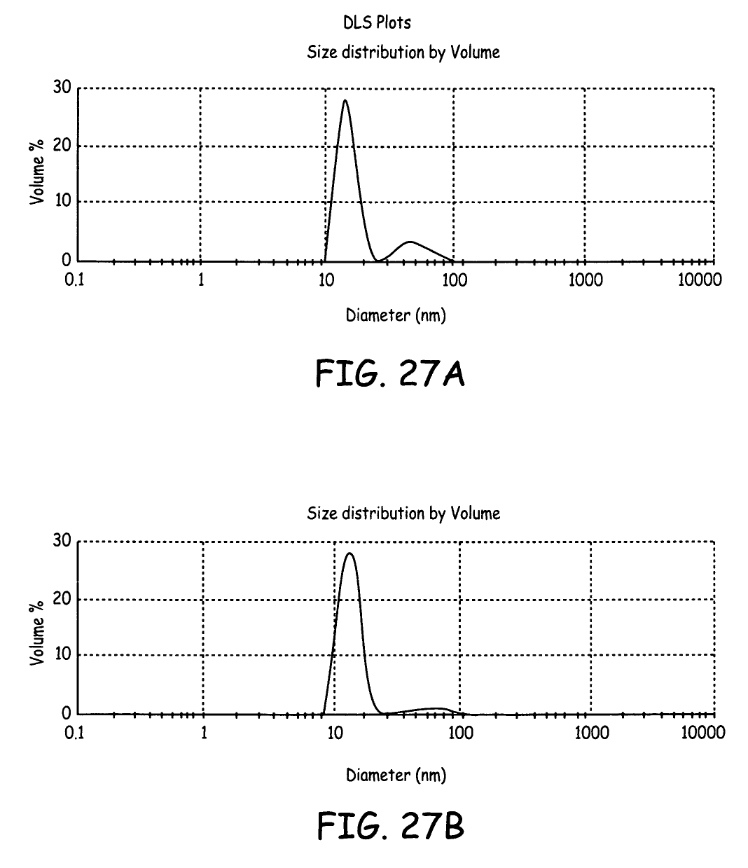

The surface modified particles were dispersed. Measurements of volume percent as a function of particle diameter in the dispersion are plotted for two samples in FIG. 27. A majority of the particles were well dispersed with particle diameters in solution of roughly 15 nanometer and an extremely narrow distribution. A second peak indicates a small amount of some higher agglomerates.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A method for the in-flight modification of inorganic particles formed within a reactive flow, the method comprising directing an organic or silicon-based coating composition to contact an inorganic particle flow downstream from a reaction zone where the inorganic particles were formed, to modify the particles in the flow.

2. The method of claim 1 wherein the inorganic particles are formed in a reaction driven by an intense light beam.

3. The method of claim 1 further comprising intersecting the flow of inorganic particles with an inert gas to cool the inorganic particles downstream from the reaction zone, prior to directing the coating composition at the inorganic particle flow.

4. The method of claim 1 wherein the coating composition comprises a surface modification agent that chemically bonds to the particle surfaces.

5. The method of claim 1 wherein the coating composition comprises a polymer or a polymer precursor.

6. The method of claim 1 wherein the coating composition comprises a dye.

7. The method of claim 1 further comprising directing radiation at the flow of inorganic particles after directing the coating composition at the flow of inorganic particles wherein the radiation induces a reaction of the coating composition.

8. A method for the in-flight modification of inorganic particles formed within a reactive flow, the method comprising directing incoherent radiation from a radiation source to an inorganic particle flow downstream from a reaction zone where the inorganic particles were formed, to modify the inorganic particles.

9. The method of claim 8 wherein the directing of radiation comprises directing infrared light, ultraviolet light, visible light or electron beam radiation at the flow of inorganic particles.

10. A reaction apparatus comprising a reactant delivery portion, a reaction chamber, an energy source, a coating nozzle and a collector, wherein the reactant delivery portion is configured to deliver precursors for inorganic particle formation through an inlet into the reaction chamber, wherein the reaction chamber is configured to have a flow path from the inlet of the reactant delivery system to the collector, wherein the energy source is configured to deliver excitation energy to a flow of inorganic particle precursors within the flow path to establish a reaction zone, wherein the coating nozzle is operably connected to a reservoir of organic or silicon-based coating nozzle and wherein the coating nozzle is configured to deliver a coating composition to the flow path at a coating location downstream from the reaction zone.

11. The reaction apparatus of claim 10 wherein the energy source comprises an intense light source that is configured to project a beam of light through the reaction chamber to intersect the flow path.

12. The reaction apparatus of claim 10 wherein the coating location is within the reaction chamber downstream from the reaction zone.

13. The reaction apparatus of claim 10 further comprising an outlet conduit connecting the reaction chamber and the collector with a configuration to have the flow path extending through the outlet conduit to the collector, wherein the coating location is within the outlet conduit.

14. The reaction apparatus of claim 10 further comprising a radiation source configured to direct radiation to intersect the flow path.

15. The reaction apparatus of claim 14 wherein the radiation source is configured to direct radiation to intersect the flow path upstream from the coating location.

16. The reaction apparatus of claim 14 wherein the radiation source is configured to direct radiation to intersect the flow path downstream from or at an overlapping position with the coating location.

17. The reaction apparatus of claim 10 wherein the inlet has an elongated configuration characterized with a major axis and a minor axis wherein the major axis is at least a factor of three greater than the minor axis to form a flow path that is correspondingly elongated and wherein the coating nozzle has an elongated configuration oriented to intersect the elongated flow path with an elongated stream of coating composition such that the elongated dimensions approximately coincide.

18. The reaction apparatus of claim 10 further comprising an inert gas inlet operably connected to an inert gas reservoir wherein the inert gas inlet is configured to deliver inert gas to the flow path between the reaction zone and the coating location.

19. A reaction apparatus comprising a reactant delivery portion, a reaction chamber, an energy source, a radiation source and a collector, wherein the reactant delivery portion is configured to deliver precursors for inorganic particle formation through an inlet into the reaction chamber, wherein the reaction chamber is configured to have a flow path from the inlet of the reactant delivery system to the collector, wherein the energy source is configured to deliver excitation energy to a flow of inorganic particle precursors within the flow path to establish a reaction zone, wherein the radiation source is configured to deliver radiation to the flow path at a transformation location downstream from the reaction zone and wherein the radiation source directs incoherent infrared light, microwave radiation, visible light, x-ray radiation, an electron beam, a corona discharge or a combination thereof.
